(19) United States
(12) Patent Application Publication
(10) Pub. No.: US 2015/0002559 A1
(43) Pub. Date: Jan. 1, 2015

(54) VIDEO DISPLAY DEVICE AND TELEVISION RECEIVING DEVICE

(71) Applicants: Toshiyuki Fujine, Osaka-shi (JP); Yoji Shiraya, Osaka-shi (JP)

(72) Inventors: Toshiyuki Fujine, Osaka-shi (JP); Yoji Shiraya, Osaka-shi (JP)

(73) Assignee: SHARP KABUSHIKI KAISHA, Osaka-shi (JP)

(21) Appl. No.: 14/377,344

(22) PCT Filed: Jul. 10, 2012
(86) PCT No.: PCT/JP2012/067599

§ 371 Date: Aug. 7, 2014

(30) Foreign Application Priority Data
Feb. 17, 2012 (JP) 2012-032350

(51) Int. Cl. G09G 3/34; H04N 9/64

(52) U.S. Cl. CPC G09G 3/3413; H04N 9/64; G09G 2320/0233; G09G 2320/0242; G09G 2320/066
USPC 345/690

(57) ABSTRACT

The objective of the present invention is, by detecting a portion of a video signal that is light emission, enhancing the display luminance of the light emission portion and displaying the same, to increase a sense of brightness for the same so as to perform video image expression with high contrast. A light emission detecting portion uses a predetermined feature quantity related to brightness of an input video image signal in order to pre-define the amount of emitted light of the video image signal according to the relationship with a feature quantity so as to detect the amount of emitted light on the basis of the feature quantity for each frame of the input video image signal. A black detection portion, from the input video image signal, detects the amount of black to display on the basis of a predetermined condition. A backlight luminance stretch portion performs stretching of the light source luminance of the backlight in accordance with the amount of emitted light that has been detected, wherein the luminance stretch amount for the backlight is limited on the basis of the amount of black to display that has been detected by the black detection portion.

### TECHNICAL FIELD

The present invention relates to a video display device and a television receiving device and, more particularly, to a video display device and a television receiving device that have a function of stretching the luminance of a backlight light source and a video signal for improving the image quality of displayed video.

### BACKGROUND OF THE INVENTION

Recently, a display technique for a TV receiver has been studied. Related to such a technique, a technique for high dynamic range imaging (HDR) by which objects in the natural world are faithfully reproduced and displayed has been studied actively. One purpose of HDR is to, for example, faithfully reproduce a luminescent color part on a screen, such as fireworks and neon signs, to create a feeling of brightness.

In such a case, a luminescent color and a body color are detected and separated from each other by a luminescent color detecting function, and only the luminescent color on the screen can be brightened through signal processing and controlling of the light-emission luminance of a backlight. Out of variations of video, a relatively bright light emission part is detected based on a distribution of the luminance of the video, and the detected light emission part is stretched intentionally. Hence the light emission part is highlighted on the screen, which offers an effect of improving image quality.

As a conventional technique, for example, patent document 1 discloses a video display device that performs light quantity control according to an input video signal and video signal processing tied to the light quantity control. This video display device generates histogram data based on the video signal, and based on that histogram data, performs light control so that a light quantity at a light source becomes smaller as the rate of tones representing black becomes larger. The device retains first tone correction data that determines the input tone vs. output tone characteristics of the video signal, generates additional data that grows larger as the rate of tones representing black becomes larger based on the histogram data, and adds the created data to the first tone correction data for each tone in the intermediate tone area in order to raise tones in a given intermediate tone area of the video signal.

### PRIOR ART DOCUMENT

### Patent Documents

Patent Document 1: Japanese Laid-Open Patent Publication No. 2008-20887

### SUMMARY OF THE INVENTION

### Problem to be Solved by the Invention

As described above, according to the HDR technique, a bright light emission part on the screen is detected and the display luminance of the light emission part is stretched. This gives the human eyes an improved contrast feeling and an enhanced feeling of brightness, thereby provides displayed video of high quality. In this case, however, the color of a nearly black part, such as a night sky, cannot be darkened by signal processing, and signal processing on such a part results in so-called conspicuous black float that deteriorates video quality, which is a problem.

The video display device of patent document 1 controls a light quantity and a video signal according to the rate of tones representing black of the video signal in such a way that the light quantity is reduced when the rate of tones representing black is high and that the output tone is raised to the same extent of the reduction in the light quantity. This is not a process of detecting a light emission part and stretching its luminance. In other words, patent document 1 does not disclose an idea of conspicuously brightening the light emission part on the screen while preventing the deterioration of video quality, such as black float.

The present invention was conceived in view of the above circumstances, and it is therefore the object of the invention to provide a video display device and a television receiving device that detect a light emission part of a video signal and stretch the display luminance of the light emission part to display the light emission part conspicuously, thereby display video with an increased feeling of brightness and high contrast and that at the same time, control luminance stretching according to a black part of the video to constantly perform highly quality video expression.

### Means for Solving the Problem

To solve the above problems, a first technical means of the present invention is a video display device comprising: a display portion for displaying an input video signal; a light source for illuminating the display portion; and a control portion for controlling the display portion and the light source, wherein the control portion determines an amount of stretching of luminance of the light source based on a given feature quantity related to brightness of the input video signal and stretches luminance of the light source based on the amount of stretching of luminance, the video display device further comprises a black detection portion that detects an amount of black display from the input video signal based on a given condition, and when an amount of black display detected by the black detection portion is within a given range, the control portion limits an amount of stretching of luminance determined based on the given feature quantity according to the amount of black display.

A second technical means is the video display device of the first technical means, wherein the control portion detects a light emission part of an input video signal based on the given feature quantity or a different feature quantity, and stretches a video signal for the light emission part to display the stretched video signal on the display portion.

A third technical means is the video display device of the second technical means, wherein the given feature quantity is a luminance value of an input video signal, wherein based on a luminance histogram for each frame of the input video signal, the control portion detects the light emission part defined in advance according to the histogram, detects a light emission quantity defined in advance according to a score given by counting pixels with luminance per pixel being weighted for an input video signal in a given range including the detected light emission part, and determines an amount of stretching of luminance of the light source according to the detected light emission quantity.

A fourth technical means is the video display device of the third technical means, wherein when an average of the luminance histogram is A and a standard deviation of the luminance histogram is σ, the control portion considers pixels equal to or larger in tone value than a threshold expressed by the following equation to be the light emission part. thresh=A+Nσ (N denotes a constant)

A fifth technical means is the video display device of the third technical means, wherein the different feature quantity is a maximum RGB tone value for each of pixels of the input video signal, and the control portion detects a light emission quantity of a light emission part defined in advance according to an average of the maximum RGB tone values of the input video signal, and determines an amount of stretching of luminance of the light source according to the detected light emission quantity.

A sixth technical means is the video display device of the third or the fourth technical means, wherein the control portion executes video processing for converting and outputting an input tone of an input video signal, and the video processing includes processing for detecting the light emission part defined in advance according to a histogram of luminance for each frame of the input video signal based on the histogram, setting a given characteristics change point in an area of the detected light emission part, applying a gain to a video signal with a tone lower than the characteristics change point so that an input tone of the input video signal at the characteristics change point is stretched to a given output tone, and setting an output tone to the input tone in an area of input tone equal to or higher than the characteristics change point, such that the output tone resulting from application of the gain at the characteristics change point is connected to a maximum output tone.

A seventh technical means is the video display device of any one of the third to the fifth technical means, wherein the control portion executes video processing for converting and outputting an input tone of an input video signal and outputting the input video signal, and the video processing includes processing for defining in advance a relation between a gain applied to a video signal and the light emission quantity and determining the gain according to the light emission quantity detected from the input video signal; applying the determined gain to the input video signal to stretch the input video signal; determining an input tone at a point at which an output tone resulting from application of the gain is stretched to a given output tone, to be a characteristics change point; outputting the video signal with the output tone resulting from application of the gain in an area of tone lower than the characteristics change point; and setting an output tone to an input tone in an area of input tone equal to or higher than the characteristics change point such that the output tone resulting from application of the gain is connected to a maximum output tone.

An eighth technical means is the video display device of the sixth or the seventh technical means, wherein the video processing includes processing for giving a prescribed gain to the input video signal to stretch the input video signal and then giving a compression gain to the video signal to reduce its output tone in a given area of a non-light emission part other than the light emission part.

A ninth technical means is the video display device of the eighth technical means, wherein the compression gain is determined to be a value that reduces an increment of display luminance resulting from stretching of luminance of the light source and stretching of a video signal by application of the gain thereto.

A tenth technical means is a video display device comprising: a display portion for displaying an input video signal; a light source for illuminating the display portion; and a control portion for controlling the display portion and the light source, wherein the control portion generates a histogram representing integrated pixels for a given feature quantity of the input video signal to detect an upper area of a given range in the histogram as a light emission part, determines an amount of stretching of luminance of the light source based on a different feature quantity of the input video signal and based on the determined amount of stretching of luminance, stretches the luminance of the light source to increase the luminance, and reduces luminance of a video signal for a non-light emission part other than the light emission part, thereby enhances display luminance of the light emission part, the video display device further comprises a black detection portion that detects an amount of black display from the input video signal based on a given condition, and when an amount of black display detected by the black detection portion is within a given range, the control portion limits an amount of stretching of luminance determined based on the given feature quantity, according to the amount of black display.

An eleventh technical means is the video display device of the tenth technical means, wherein the different feature quantity is a tone value of an input video signal, and the control portion divides an image created by the input video signal into multiple areas, changes a lighting rate in an area for the light source based on a tone value of a video signal for each of the divided areas, and determines the amount of stretching of luminance based on an average lighting rate over all the areas.

A twelfth technical means is the video display device of the eleventh technical means, wherein the control portion defines in advance a relation between the average lighting rate and maximum luminance that can be taken on a screen of the display portion, and determines the amount of stretching of luminance based on the maximum luminance determined according to the average lighting rate.

A thirteenth technical means is the video display device of the eleventh or the twelfth technical means, wherein when an average of the histogram is A and a standard deviation of the histogram is G, the control portion determines pixels equal to or larger in tone value than a threshold expressed by the following equation to be a light emission part. thresh=A+Nσ (N denotes a constant)

A fourteenth technical means is the video display device of any one of the tenth to the thirteenth technical means, wherein in a given area in which the feature quantity is small, the control portion reduces an increment of display luminance of the display portion resulting from stretching of luminance of the light source by reducing luminance of the video signal.

A fifteenth technical means is a television receiving device including the video display device of any one of the first to the fourteenth technical means.

### Effect of the Invention

The video display device of the present invention detects a light emission part of a video signal and stretches the display luminance of the light emission part to display the light emission part conspicuously, thereby performs video expression with an increased feeling of brightness and high contrast that improves video quality. According to the present invention, such a video display device and a television receiving device can be provided.

### BRIEF DESCRIPTION OF DRAWINGS

FIG. 1 is an explanatory diagram of an embodiment of a video display device according to the present invention, showing a principle part of the video display device.

FIG. 2 depicts an example of a luminance histogram generated from the luminance signal Y of an input video signal.

FIG. 3 is an explanatory diagram of another example of detecting a light emission quantity from a feature quantity.

FIG. 4 is an explanatory diagram of an example of a black detection processing by a black detection portion.

FIG. 5 depicts an example of setting a relation between a black detection score detected by the black detection portion and an enhancement proportion.

FIG. 6 is an explanatory diagram of a method of calculating a CMI from a broadcasting video signal that should be displayed by the video display device.

FIG. 7 is an explanatory diagram of another example of the black detection processing by the black detection portion.

FIG. 8 depicts a response curve representing the response of the human photoreceptor cell to luminance.

FIG. 9 depicts an example of setting a relation between a geometric average and an enhancement proportion.

FIG. 10 depicts an example of setting a relation between a light emission quantity and the basic amount of luminance enhancement.

FIG. 11 depicts an example of controlling backlight luminance according to the amount of luminance enhancement determined by a luminance enhancement quantity determination portion.

FIG. 12 is an explanatory diagram of stretching of the luminance of a video signal performed by a video signal luminance stretch portion, showing an example of setting the input/output characteristics of the video signal.

FIG. 13 is an explanatory diagram of another example of stretching of the luminance of a video signal performed by a video signal luminance stretch portion.

FIG. 14 depicts an example of setting the input/output characteristics of an input video signal when the input video signal is stretched by giving a gain thereto.

FIG. 15 depicts an example of tone mapping generated by a mapping portion.

FIG. 16 depicts another example of tone mapping generated by the mapping portion.

FIG. 17 depicts an example of a state where screen luminance is stretched.

FIG. 18 is explanatory diagrams of an effect of a luminance stretching processing according to the present invention.

FIG. 19 is an explanatory diagram of a second embodiment of the video display device according to the present invention, showing a principle part of the video display device.

FIG. 20 is explanatory diagrams of a light emission area control processing by an area-active-control/luminance-stretching portion.

FIG. 21 is other explanatory diagrams of the light emission area control processing by the area-active-control/luminance-stretching portion.

FIG. 22 is explanatory diagrams for explaining an average lighting rate determination processing in detail.

FIG. 23 is still another explanatory diagram of the light emission area control processing by the area-active-control/luminance-stretching portion.

FIG. 24 depicts an example of a Y histogram generated from the luminance signal Y of an input video signal.

FIG. 25 depicts an example of tone mapping generated by the mapping portion.

FIG. 26 is an explanatory diagram of max luminance output from the area-active-control/luminance-stretching portion.

FIG. 27 depicts a state of enhancement of screen luminance through processing performed by the area-active-control/luminance-stretching portion.

### PREFERRED EMBODIMENT OF THE INVENTION

### First Embodiment

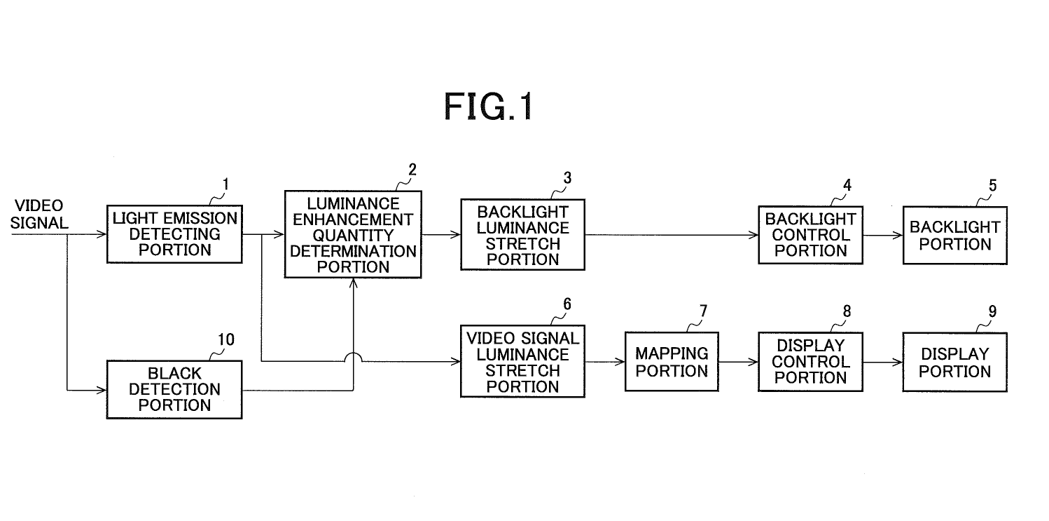

FIG. 1 is an explanatory diagram of a first embodiment of a video display device according to the present invention, showing a principle part of the video display device. The video display device has a configuration for performing image processing on an input video signal and displaying video, and can be applied to a television receiving device, etc.

A video signal separated from a broadcasting signal or an incoming video signal from an external apparatus is input to a light emission detecting portion 1 and to a black detection portion 10. Using a given feature quantity related to the brightness of the input video signal, the light emission detecting portion 1 defines the light emission quantity of the video signal in advance based on a relation between the light emission quantity and the feature quantity. The light emission detecting portion 1 then detects the light emission quantity from the feature quantity for each frame of the input video signal.

For example, a Y histogram representing integrated pixels for each tone of a luminance signal Y is generated for each frame of the input video signal, using the luminance of the video signal as the feature quantity, and a light emission part is detected from the Y histogram. The light emission part is determined by the average and the standard deviation of the Y histogram and is detected as a relative value for each Y histogram.

In determining the feature quantity (luminance) of the light emission part, pixels are integrated such that the sum of pixels for higher luminance is weighted with a larger weight. In this manner, the light emission quantity is detected for each frame. The light emission quantity represents the extent of luminescence of the input video signal, serving as an index for executing stretching of the luminance of a backlight and stretching of the luminance of the video signal.

In another example of luminescence detection by the light emission detecting portion 1, the highest tone value (Max RGB) is extracted from tone values of an RGB video signal making up one pixel, the average (Max RGB Ave) of tone values extracted from all pixels in one frame is calculated, and the calculated average is used as a feature quantity. The Max RGB Ave for each pixel can be used as a feature quantity related to the brightness of video. A relation between the Max RGB Ave and the light emission quantity representing the extent of luminescence of the video signal is defined in advance. For example, according to the defined relation, an area where the Max RGB Ave is high to some extent is regarded as light emission area, in which the light emission quantity is set high. For each frame of input video, the light emission quantity for the frame is obtained from the Max RGB Ave.

The black detection portion 10 detects an amount (number of pixels) representing black display, from an input video signal. Hereinafter, the amount representing black display will be simply referred to as the amount of black and a process of detecting the amount representing black display will be explained as a black detection processing.

The details of the black detection processing will be described later. The amount of black is detected for each frame from the input video signal, through a given calculation process. Based on a pre-defined relation between the amount of black and the rate of enhancement of the backlight luminance, a luminance enhancement proportion corresponding to the detected amount of black is determined and is output to a luminance enhancement quantity determination portion 2. The luminance enhancement proportion is used to limit and adjust the basic amount of luminance enhancement according to the amount of black display, the basic amount of luminance enhancement being determined based on the light emission quantity of a light emission part detected by the light emission detecting portion 1.

The luminance enhancement quantity determination portion 2 determines the amount of luminance enhancement used for performing enhancement of the backlight luminance, based on the light emission quantity of an input video signal detected by the light emission detecting portion 1 and the rate of luminance enhancement output from the black detection portion 10.

In this process, the luminance enhancement quantity determination portion 2 first determines the basic amount of luminance enhancement based on a light emission quantity output from the light emission detecting portion 1. In this case, a relation between the amount of luminance enhancement and the light emission quantity is determined in advance, and the luminance enhancement quantity determination portion 2 determines the basic amount of luminance enhancement based on the light emission quantity output from the light emission detecting portion 1. For example, the basic amount of luminance enhancement is determined such that it is increased in an area where the light emission quantity is high to some extent. As a result, the basic amount of luminance enhancement is set higher for an image with the larger light emission quantity.

The luminance enhancement quantity determination portion 2 then multiplies the basic amount of luminance enhancement by an enhancement proportion based on the amount of black detected by the black detection portion 10 to determine an increment of luminance enhancement. This increment of luminance enhancement is added to a luminance level in a state of no luminance enhancement. The luminance level in the state of no luminance enhancement is a predetermined luminance level, which is, for example, a luminance level at which screen luminance at the time of display of a video signal with the maximum tone is 450 cd/m². In this manner, the final amount of luminance enhancement is determined.

A backlight luminance stretch portion 3 stretches backlight luminance to increase the luminance of a light source (e.g., LED) of a backlight portion 5, based on the amount of luminance enhancement determined by the luminance enhancement quantity determination portion 2. The luminance of the LED of the backlight portion 5 is controlled by pulse width modulation (PWM) and may be adjusted to a desired luminance value by current control or a combination of the current control and the PWM control.

A video signal luminance stretch portion 6 increases a gain of an input video signal, thereby stretches the luminance of the video signal. In this case, for the light emission part obtained from the average and standard deviation of the above luminance histogram, the video signal can be stretched by a given gain increase or by using a gain determined by a light emission quantity calculated from the luminance histogram or Max RGB Ave.

A mapping portion 7 generates tone mapping of the input/output characteristics of a video signal (response characteristics of the output tone to the input tone). In this case, if tone mapping of the input/output characteristics is performed using a gain determined by the video signal luminance stretch portion 6 and applied directly to the tone mapping, an area of the video signal other than the light emission part is also stretched, which results in an increase in the screen luminance. To avoid this, for a non-light emission part on the low-tone side, the tone mapping is performed as the output tone to the input tone is reduced. As a result, according to the input/output characteristics subjected to the tone mapping, an area where the video signal is stretched becomes a bright area with high tone and control for further brightening a bright area through video signal processing is performed.

The mapping portion 7 outputs control data for controlling the display portion 9 to a display control portion 8, which controls the display operation of the display portion 9, based on the control data. The display portion 9 equips a liquid crystal panel that is illuminated with the LED of the backlight portion 5 to display an image.

According to the above configuration, the amount of stretching of luminance of the backlight portion 5 is determined based on a light emission quantity detected by the light emission detecting portion 1. As a result, control can be performed to further brighten bright video with a large light emission quantity. At this time, the amount of luminance stretching determined based on the light emission quantity detected by the light emission detecting portion 1 is limited. For example, the amount of luminance stretching is reduced further as the amount of black glows larger. As a result, when bright video with a large light emission quantity is brightened further, if the video includes many black areas because of which strong luminance enhancement results in conspicuous black float, the amount of luminance stretching is limited to suppress black float and allow display of highly quality video.

Increasing a gain of the video signal through video signal processing is performed according to a light emission area of the Y histogram and a detected light emission quantity. In addition, through tone mapping, luminance reduction is performed on a part regarded as a non-light emission part other than the light emission part. Hence the screen luminance of the light emission part is increased, which allows video expression with high contrast, thus improving image quality.

As an example of control over the backlight portion 5 and the display portion 9, an area active control method can be adopted, according to which a video area is divided into multiple areas and each light source of the backlight portion 5 that corresponds to each of the divided areas is controlled.

According to the area active control, video is divided into multiple given areas from each of which a maximum tone value of a video signal is extracted, and the lighting rate of an LED for each area is determined according to the extracted maximum tone value. In this example, the maximum tone value for each divided area may be replaced with a different statistic value, such as an average tone value for each divided area. For example, in a dark area with a low maximum tone value, the lighting rate is lowered to reduce the luminance of the backlight. In this state, according to the amount of luminance enhancement, the total input power of the backlight as a whole is increased to increase the overall luminance of the backlight. This further brightens already bright, light emission video, thus creating a stronger feeling of brightness.

On a non-light emission part, a luminance increment equivalent to the amount of luminance stretching is reduced through the video signal processing. As a result, the luminance of the light emission part only is enhanced on the screen and therefore highly quality video with high contrast can be displayed.

In another example of control over the backlight portion 5 and the display portion 9, the above area active control method may not be adopted and the light-emission luminance of the whole light source of the backlight portion 5 may be stretched according to the amount of luminance enhancement determined by the luminance enhancement quantity determination portion 2. In this case, already bright, light emission video is further brightened to create a stronger feeling of brightness. On the non-light emission part, a luminance increment equivalent to the amount of luminance stretching is reduced through the video signal processing. As a result, the luminance of the light emission part only is enhanced on the screen and therefore highly quality video with high contrast can be displayed.

According to this embodiment, a control portion of the present invention controls the backlight portion 5 and the display portion 9. The control portion is equivalent to the light emission detecting portion 1, luminance enhancement quantity determination portion 2, backlight luminance stretch portion 3, backlight control portion 4, video signal luminance stretch portion 6, mapping portion 7, and display control portion 8.

When the above display device is configured as a television receiving device, the television receiving device has a means that tunes a broadcasting signal received by an antenna to a selected channel and that generates a reproduction video signal by demodulating and decoding the signal. The television receiving device properly executes given image processing on the reproduction video signal and inputs the processed signal as the input video signal shown in FIG. 1. Hence the received broadcasting signal is displayed on the display portion 9. The present invention provides the video display device and the television receiving device having the video display device.

Examples of processes by the component portions of this embodiment having the above configuration will hereinafter be described in detail.

A luminescence detection processing by the light emission detecting portion 1 will first be described in detail.

As described above, using a given feature quantity related to the brightness of an input video signal, the light emission detecting portion 1 defines in advance the light emission quantity of the video signal based on a relation between the light emission quantity and the feature quantity. The light emission detecting portion 1 then detects the light emission quantity from the feature quantity for each frame of the input video signal.

### (Luminescence Detection Processing 1)

In a first example of the luminescence detection processing, a luminance histogram representing integrated pixels corresponding to a luminance level for each frame of an input video signal is generated, using the luminance of the video signal as a feature quantity, and a light emission part is detected from the histogram for each frame.

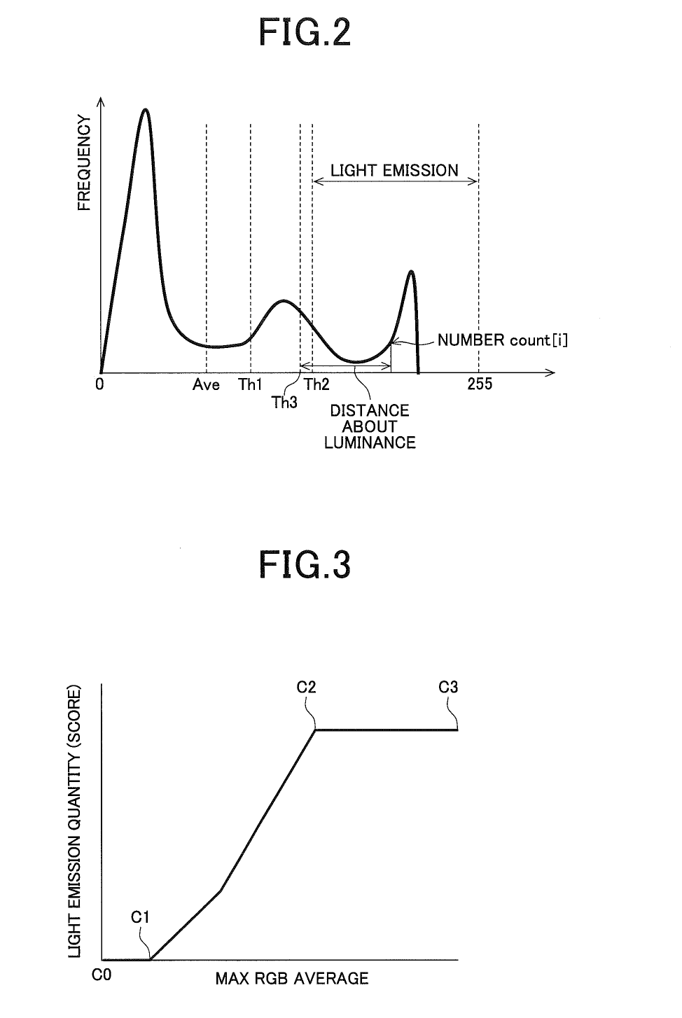

FIG. 2 depicts an example of a luminance histogram generated from the luminance signal Y of an input video signal. The light emission detecting portion 1 generates a Y histogram by integrating pixels for each luminance tone for each frame of the input video signal. The horizontal axis of the histogram represents the tone value for the luminance Y, on which horizontal axis, for example, the maximum value is 255 tones when the video signal is expressed in 8 bits. The vertical axis represents the number of pixels (frequency) integrated for each tone value. When the Y histogram is generated, an average (Ave) and a standard deviation (σ) are calculated from the Y histogram and two thresholds Th are calculated using the average (Ave) and standard deviation (σ).

A second threshold Th2 is a threshold that defines a luminescence boundary. On the Y histogram, pixels equal to or larger in tone value than the threshold Th2 are considered to be a light emission part in execution of the luminescence detection processing.

The second threshold Th2 is defined as

Th2=Ave.+Nσ Eq. (1)

where N denotes a given constant.

A first threshold Th1 is set for suppressing a feeling of oddness in tone in an area smaller in tone value than the threshold Th2 and is defined as

Th1=Ave.+Mσ Eq. (2)

where M denotes a given constant and M<N is satisfied.

In this example, a third threshold Th3 is also set. The threshold Th3 is located between the thresholds Th1 and Th2 and is set for detecting a light emission quantity. The light emission quantity is defined as an index indicative of the extent of luminescence of the light emission part, and is defined in advance based on the relation between the light emission quantity and the feature quantity. In this example, the light emission quantity is calculated as a score by the following calculation.

The threshold Th3 may be set equal to the threshold Th2 but is actually set as a different threshold so that a margin is given to the light emission part equal to or larger in tone value than the threshold Th2 to execute the light emission detection processing easily in a broader area.

Hence the threshold Th3 is defined as

Th3=Ave.+Qσ(M<Q≦N) Eq. (3)

The score (light emission quantity) is defined as [rate of pixels equal to or higher in tone value than a certain threshold]×[distance from threshold (luminance difference)], and is calculated by counting pixels having tone values larger than the threshold Th3 and weighting the distance from the threshold Th3. The score represents an extent of brightness, and is calculated by, for example, the following equation (4).

$$\begin{matrix}[ Eq . 1 ] & \\ Score = 1000 \times {\sum }_{i > Th 3}^{ } \{ ( count [ i ] \times ( {i}^{2} - {( Th 3 )}^{2} ) / Total Number of Pixels \times {( Th 3 )}^{2} ) \} & ( 4 )\end{matrix}$$

In the equation (5), count[i] denotes the count of pixels for a tone value i, and i²−(Tresh3)² denotes a distance about luminance (luminance difference) shown in FIG. 2, which may be replaced with the distance from the threshold in terms of intensity L*. i² represents luminance, where to the 2 is actually i to the 2.2. This means that when a digital code value is i, luminance is i^{2.2}, at which intensity L is (i^{2.2})^{1/3}≈i. A result of verification by the video display device demonstrates that the distance from the threshold in terms of luminance is more effective than the distance from the threshold in terms of intensity. In the equation (4), the total number of pixels is not limited to i>Th3 but represents a value given by counting all the pixels. When such a calculated value is adopted as a score, a high score results when the light emission part includes many high tone pixels separated from the threshold Th3. Even when the number of pixels equal to or higher in tone value than the threshold Th3 is constant, if many high tone pixels are included, a high score results.

### (Luminescence Detection Processing 2)

FIG. 3 is an explanatory diagram of another example of detecting a light emission quantity from a feature quantity. In this example, a value given by averaging the highest tone value (Max RGB) among tone values of an RGB video signal making up one pixel in all pixels in a frame (Max RGB average (Max RGB Ave)) is used as the feature quantity of an input video signal.

As shown in FIG. 3, a relation between the calculated Max RGB Ave and the light emission quantity (score) is determined in advance. In this example, in an area extending from a point CO at which the Max RGB Ave is the minimum to a middle point C1, the light emission quantity (score) is zero. It is therefore considered that no luminescence occurs in this area. In an area between the point C1 and a point C2 (C1<C2), the light emission quantity increases with an increase in the Max RGB Ave. In an area between the point C2 and a point C3 (in which the Max RGB Ave takes the maximum), the light emission quantity is constant at its maximum level.

According to the pre-defined characteristics shown in FIG. 3, the light emission detecting portion 1 determines the light emission quantity (score) corresponding to the calculated Max RGB Ave.

### (Black Detection Processing 1)

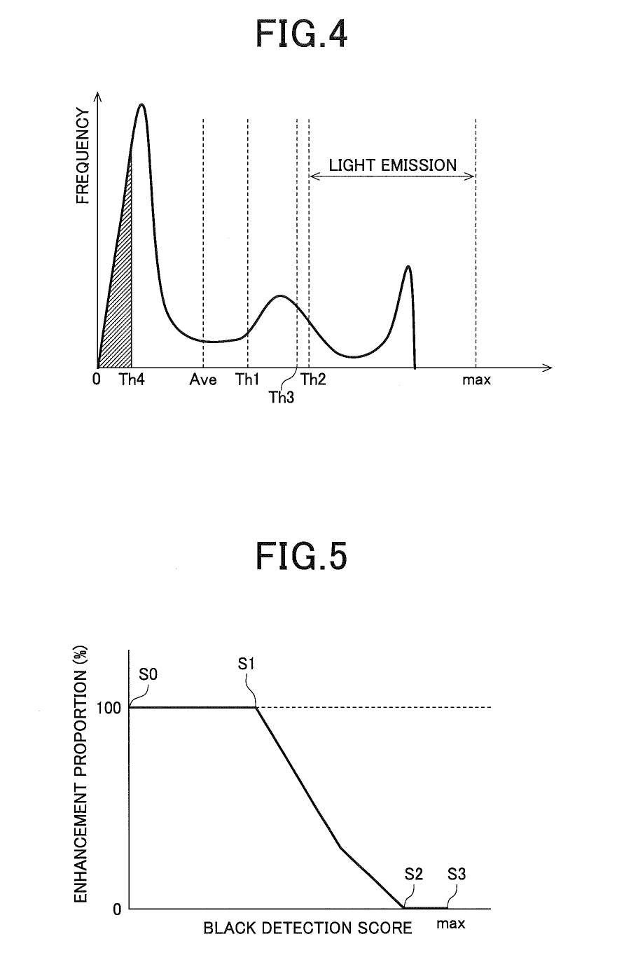

FIG. 4 is an explanatory diagram of an example of a black detection processing by the black detection portion. According to the processing of this example, the black detection portion 10 generates a Y histogram by integrating pixels for each luminance tone for each frame of an input video signal. The black detection portion 10 may generate a different histogram (Max RGB histogram) by integrating highest tone values (Max RGB) among the tone values of an RGB video signal making up each pixel or a different histogram (CMI histogram) by calculating a color mode index (CMI) indicating how bright an intended color is for each pixel and integrating indexes for the number of pixels. If a histogram generated by the light emission detecting portion 1 is usable, the black detection portion 10 may use that histogram. While an example of use of a luminescence histogram will be described in the following explanation, the same processing as described in the following explanation can be executed in a case of use of a histogram different from the luminescence histogram.

FIG. 4 depicts any one of the above histograms. The black detection portion 10 sets a fourth threshold Th4 for indicating a black area. Pixels included in a luminance area equal to or lower in tone value than the fourth threshold Th4 are treated as pixels for black display. The pixels included in the area equal to or lower in tone value than the threshold Th4 are counted and a score of black display (black detection score) is determined. The black detection score is calculated at the maximum score when all pixels in the frame are included in the black area, and is calculated at zero when no pixel is included in the black area. The black detection score, therefore, is determined according to the counted number of pixels.

FIG. 5 depicts an example of setting a relation between a black detection score and an enhancement proportion. The black detection portion 10 defines in advance the relation depicted in FIG. 5. The black detection portion 10 then determines an enhancement proportion according to a black detection score obtained from the histogram of FIG. 4. In FIG. 5, in an area between a point S0 and a point S1 in which the black detection score is relatively low and therefore little black display exists, the enhancement proportion is kept at 100%. In this area, the influence of black float is small because of a small area of black display, which eliminates a need of limiting the amount of luminance enhancement determined according to a light emission quantity. In this area, therefore, the enhancement proportion is set to 100% to emphasize a feeling of brightness of a bright part that is created by luminance enhancement.

In an area between the point S1 and a point S2 in which the black detection score is at a middle level, the enhancement proportion is lowered as the black detection score increases, that is, as the amount of black increases. Because an increase in black display leads to conspicuous black float, the amount of luminance enhancement determined according to the light emission quantity is limited to suppress black float. In an area between the point S2 and a point S3 in which the black detection score is high (score=max), the screen includes many black display areas for which reason the enhancement proportion is set to zero. Hence luminance enhancement according to the light emission quantity is not performed so that the backlight is turned on with its luminance set to a standard level.

The definition of the CMI will then be described. The color mode index (CMI) can be used as a feature quantity used for generating a histogram. The CMI is the index indicating how bright an intended color is. Different from luminance, the CMI indicates brightness together with color information. The CMI is defined as

L*/L*modeboundary×100 Eq. (5)

“L*” is an index of the relative brightness of a color, and when L* is L*=100, indicates the intensity of white that is most bright as an object color. In Eq. (5), L* is the intensity of the noted color and “L*modeboundary” is the intensity of the boundary observed as emitting light at the same chromaticity as that of the noted color. In this case, it is known that L*modeboundary≈the intensity of the brightest color (the brightest color of object colors). The intensity of a color whose CMI is CMI=100 is referred to as “light emitting color boundary” and it is defined that a CMI exceeding 100 represents emission of light.

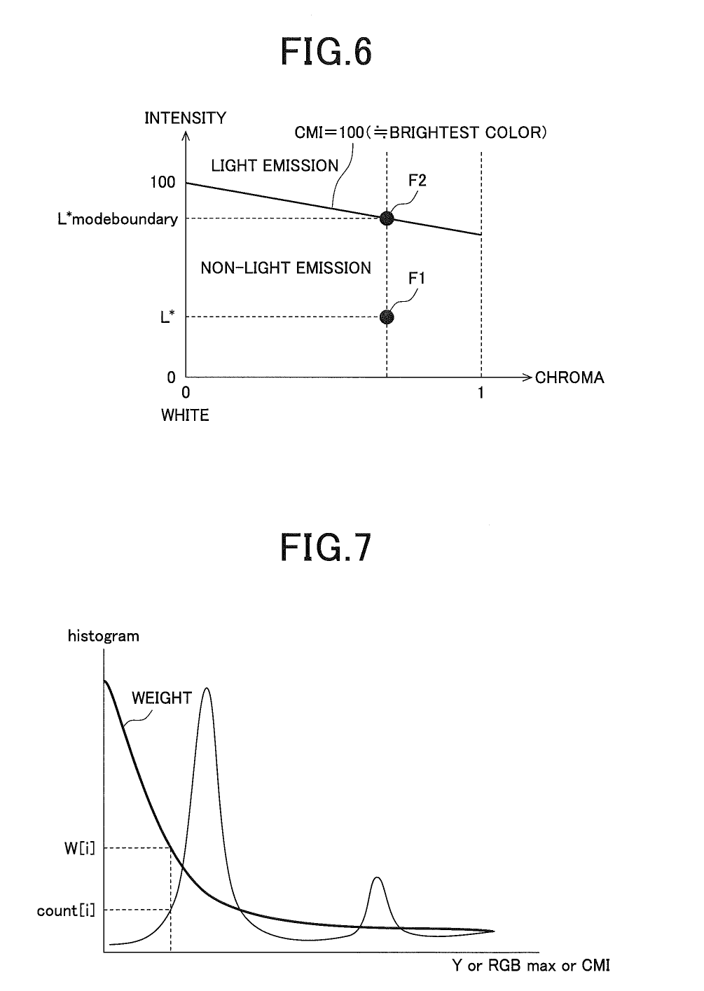

An approach of calculating the CMI from the broadcast video signal to be displayed on the video display device will be described with reference to FIG. 6. The broadcast video signal is normalized and transmitted based on the BT.709 standard. Therefore, the RGB data of the broadcast video signal is converted into data of the tri-stimulus values X, Y, and Z using a conversion matrix for the BT.709. The intensity L* is calculated using a conversion equation starting with that of Y. It is assumed that L* of the noted color is located at a position F1 of FIG. 6. The chromaticity is calculated from each of the converted X, Y, and Z, and L*(L*modeboundary) of the brightest color at the equal chromaticity to that of the noted color is checked from the data of the brightest color already known. The position in FIG. 6 is F2.

From these values, the CMI is calculated using Eq. (5) above. The CMI is represented by the ratios of the L* of the noted pixel and the L*(L*modeboundary) of the brightest color at the chromaticity of the noted pixel.

The CMI is acquired for each pixel of the video signal using the above approach. The broadcast signal is normalized, and therefore, all the pixels each take any one CMI in a range from zero to 100. A CMI histogram is produced for one frame video using the axis of abscissa that represents the CMI and the axis of ordinate that represents the frequency.

### (Black Detection Processing 2)

FIG. 7 is an explanatory diagram of another example of the black detection processing by the black detection portion. According to the processing in this example, in the same manner as in the above black detection processing 1, a Y histogram or a Max RGB histogram or a CMI histogram is generated. If the histogram generated by the light emission detecting portion 1 is usable, that histogram may be used.

The black detection portion 10 detects the amount of black for each frame from the generated histogram. At this time, the black detection portion 10 calculates a black detection score as a parameter given by weighting black.

The black detection score is calculated by the following equation.

SCORE (black detection score)=(Σcount[i]×W[i])/Σcount[i] Eq. (6)

where count[i] denotes the frequency (number of pixels) of the i-th feature quantity (luminance, Max RGB, CMI, etc.) of the histogram, and W[i] denotes the i-th weight. A function for determining the weight can be set arbitrarily.

FIG. 7 depicts an example in which a weighting function W[i] is set. Basically, the weight is increased as the feature quantity of the histogram decreases (as the luminescent color becomes closer to black). The integrated value of pixels for each feature quantity is multiplied by the weight to calculate the black detection score based on the function for weighting black.

The relation between the black detection score and the enhancement proportion can be determined to be the same as the relation of FIG. 5. Therefore, in the area between the point S0 and the point S1 in which the black detection score is relatively low and therefore little black display exists, the enhancement proportion is kept at 100%. In the area between the point S1 and a point S2 in which the black detection score is at a middle level, the enhancement proportion is lowered as the black detection score increases, that is, as the amount of black increases. In the area between the point S2 and a point S3 in which the black detection score is high (score=max), the screen includes many black display areas for which reason the enhancement proportion is set to zero. Hence luminance enhancement according to the light emission quantity is not performed so that the backlight is turned on with its luminance set to a standard level.

### (Black Detection Processing 3)

In still another example of the black detection processing by the black detection portion 10, a geometric average (GAve), which is an index for the average luminance of a video signal that is compatible with the human visual performance, is used. The GAve is a luminance average given by calculating not the average of signal luminance but the average of liquid crystal panel luminance, as an average compatible with the visual performance. For example, the Gave is expressed by the following equation (7).

$$\begin{matrix}[ Eq . 2 ] & \\ GeometricAve . = exp ( \frac{1}{n} {\sum }_{picxels} log ( δ + {Y}_{lum} ) ) & ( 7 )\end{matrix}$$

In the equation (7), δ is a minute value that prevents the occurrence of log 0. For example, δ is a value representing the minimum luminance perceivable to persons. For example, δ may be set to 0.00001. Ylum denotes the panel luminance of each pixel, taking a value of 0 to −0.1. Ylum can be expressed as (signal luminance/max luminance)̂γ. n and pixels denote the total number of pixels. The equation (7) thus expresses the power of the logarithmic mean of the tone values of pixels of an image. In other words, it expresses a geometric mean.

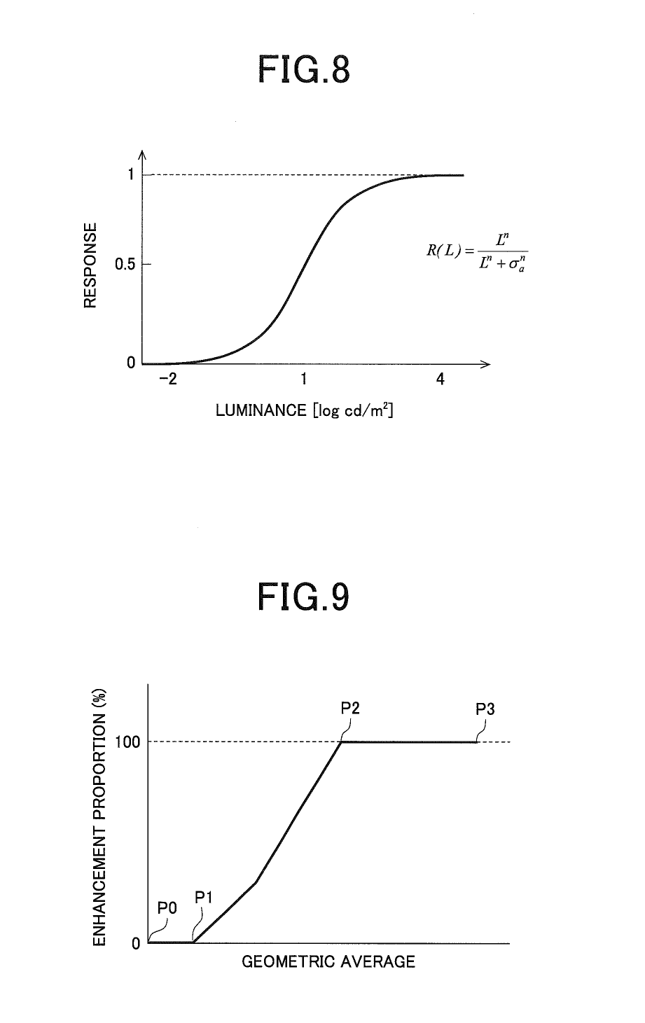

FIG. 8 depicts a response curve representing the response of the human photoreceptor cell to luminance. As indicated in FIG. 8, the human photoreceptor cell response curve depends on luminance values expressed in logarithm (luminance (log cd/m²)). This response curve represents an equation that is generally referred to as Mickaelis-Menten equation.

As described above, the GAve is the power of the logarithmic mean of the tone values of pixels. It is therefore can be said that the GAve is a numerical expression of the human eyes' response to an image (how bright an image is to the human eyes). In other words, the GAve is considered to be a value familiar to human perception. Hence the GAve is used as a feature quantity and an enhancement proportion corresponding to the GAve is determined.

In this example, when an input video signal is input to the black detection portion 10, the GAve is calculated first. The GAve is calculated by the following process according to the equation (7).

(S1) Normalize tone values for each pixel of the histogram and take the γ power of the normalized value to calculate a panel luminance value. Sum up the minimum luminance value and the panel luminance value and take the logarithmic value of the resulting sum for log 10.

(S2) Sum up logarithmic values for log 10 for all pixels.

(S3) Take the power of the average of the resulting sum.

FIG. 9 depicts an example of setting a relation between a geometric average and an enhancement proportion. The black detection portion 10 defines the relation of FIG. 9 in advance. The black detection portion 10 then determines an enhancement proportion according to a geometric average for each frame calculated from an input video signal. In this example, in an area between a point P0 and a point P1 in which the geometric average is relatively low and therefore plenty of black display exists, the enhancement proportion is set to 0%. Because an increase in black display leads to conspicuous black float, the amount of luminance enhancement determined according to the geometric average familiar to the human perception is reduce to 0% so that black float is kept unnoticeable.

In an area between the point P1 and a point P2 in which the geometric average is at a middle level, the enhancement proportion is raised as the geometric average increases, that is, as the amount of black decreases. Because a decrease in black display results in less influence of black float, the luminance enhancement proportion is raised as the geometric average increases. In an area between the point P2 and a point P3 in which the geometric average is high (geometric average=max), the screen includes little black display area, for which reason the enhancement proportion is set to 100% so that a feeling of brightness of a light emission part created by luminance enhancement is emphasized.

### (Luminance Enhancement Quantity Determination Processing)

The luminance enhancement quantity determination portion 2 determines the amount of luminance enhancement based on a light emission quantity output from the light emission detecting portion 1 and an enhancement proportion output from the black detection portion 10.

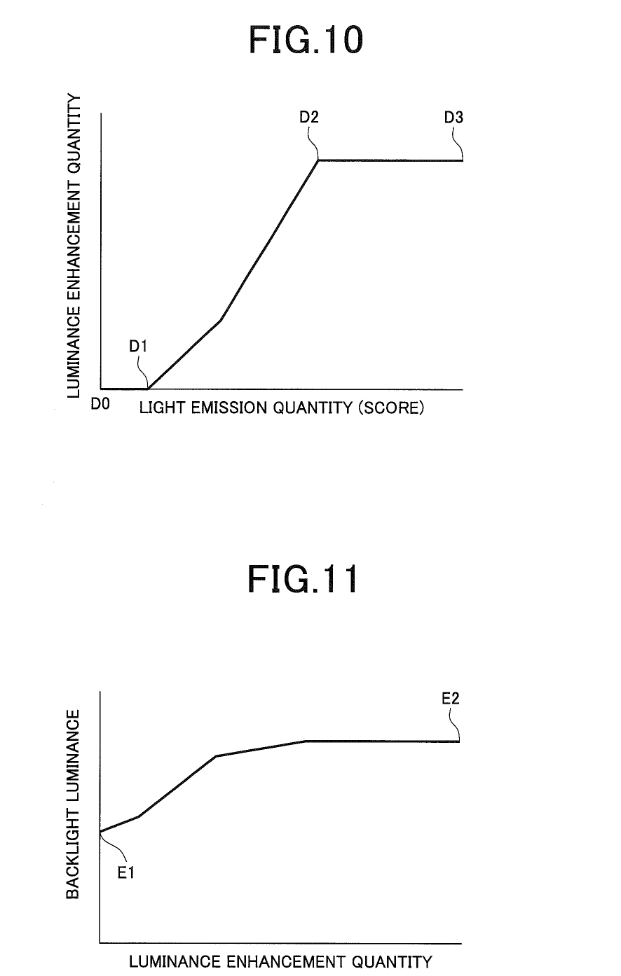

In this process, the luminance enhancement quantity determination portion 2 first determines the basic amount of luminance enhancement based on a light emission quantity (score) detected by the light emission detecting portion 1. FIG. 10 depicts an example of setting a relation between a light emission quantity and the basic amount of luminance enhancement. The amount of luminance enhancement is the amount indicating the maximum luminance intended for display. For example, the amount of luminance enhancement can be expressed as a factor of multiplication of screen luminance (cd/m²), luminance stretching, etc. The maximum luminance intended for display is, for example, the screen luminance that results when the video signal has the maximum tone (255 tones in the case of 8-bit expression).

In the example of FIG. 10, in an area in which the light emission quantity is at a level higher than a certain level (area between a point D2 and a point D3 (maximum light emission quantity)), the amount of luminance enhancement is set to a constant high level to stretch the luminance of video with high tone to give the video high luminance, thereby increase a feeling of brightness. In this example, on a part where the score is higher than a certain level, the amount of luminance enhancement is set so that the maximum luminance of the screen resulting from luminance stretching is, for example, 1500 (cd/m²). In an area in which the light emission quantity is lower than the light emission quantity at the point D2 (area between a point D1 and the point D2 (D1<D2)), the amount of luminance enhancement is set so that the amount of luminance stretching becomes smaller as the light emission quantity becomes smaller. In an area in which the light emission quantity is the minimum (area between a point D0 (light emission quantity=0) and the point D1), luminance enhancement is not performed. This is because that with few light emission parts with little light emission quantity, luminance enhancement in this area produces less result. In this case, the maximum luminance of the screen is determined to be, for example, 450 cd/cm².

In FIG. 10, the amount of luminance enhancement is determined according to the light emission quantity. This determined amount of luminance enhancement is the basic amount of luminance enhancement before limitation of luminance stretching performed according to black detection. The luminance enhancement quantity determination portion 2 multiplies the basic amount of luminance enhancement by an enhancement proportion output from the black detection portion 10 to determine the final amount of luminance enhancement actually applied to the backlight. For example, when the basic amount of luminance enhancement determined based on the light emission quantity is V, standard luminance in the case of executing no luminance enhancement is X, the enhancement proportion output from the black detection portion 10 is W, and the final amount of luminance enhancement applied to the backlight is Z, the final amount of luminance enhancement is determined by the following equation.

Amount of luminance enhancement=(V−X)×W+X (8)

The amount of luminance enhancement Z is the amount indicating the maximum luminance intended for display. For example, the amount of luminance enhancement Z is expressed as a factor of multiplication of screen luminance (cd/m²), luminance stretching, etc. The maximum luminance intended for display is, for example, the screen luminance that results when the video signal has the maximum tone (255 tones in the case of 8-bit expression).

### (Backlight Luminance Stretch Processing)

FIG. 11 depicts an example of controlling backlight luminance according to the amount of luminance enhancement determined by the luminance enhancement quantity determination portion.

The backlight luminance stretch portion 3 stretches the light source luminance of the backlight portion 5, using the amount of luminance enhancement determined by the luminance enhancement quantity determination portion 2. In this example, the backlight control portion 4 controls the backlight portion 5 according to the amount of luminance stretching determined by the backlight luminance stretch portion 3.

Luminance stretching is performed, for example, according to pre-defined characteristics shown in FIG. 11. In FIG. 11, the horizontal axis represents the amount of luminance enhancement determined by the luminance enhancement quantity determination portion 2 and the vertical axis represents the luminance level of the backlight, which is determined by, for example, the drive duty, drive current value, etc., of the backlight.

For example, the maximum luminance of the screen that results when the backlight is turned on normally without being subjected to luminance stretching is set to 450 cd/m². In this setting, in a case of a dark image including more black areas than a given number of black areas, an enhancement proportion is determined to be zero. The amount of luminance enhancement expressed by the equation (8) is, therefore, set to the lowest level. Hence the luminance level of the backlight is controlled to a luminance level at a point E1 shown in FIG. 11.

When the amount of luminance enhancement increases from the point E1, as shown in FIG. 11, the luminance of the backlight is stretched widely in correspondence to the increase in the amount of luminance enhancement. At a point E2 at which the amount of luminance enhancement becomes the maximum, for example, the luminance of the backlight is stretched so that the maximum screen luminance is set to 1500 cd/m². Through such control, the luminance of the backlight is stretched according to a light emission quantity detected from an input video signal. As a result, a feeling of brightness of a light emission part can be increased.

### (Video Signal Luminance Stretch Processing 1)

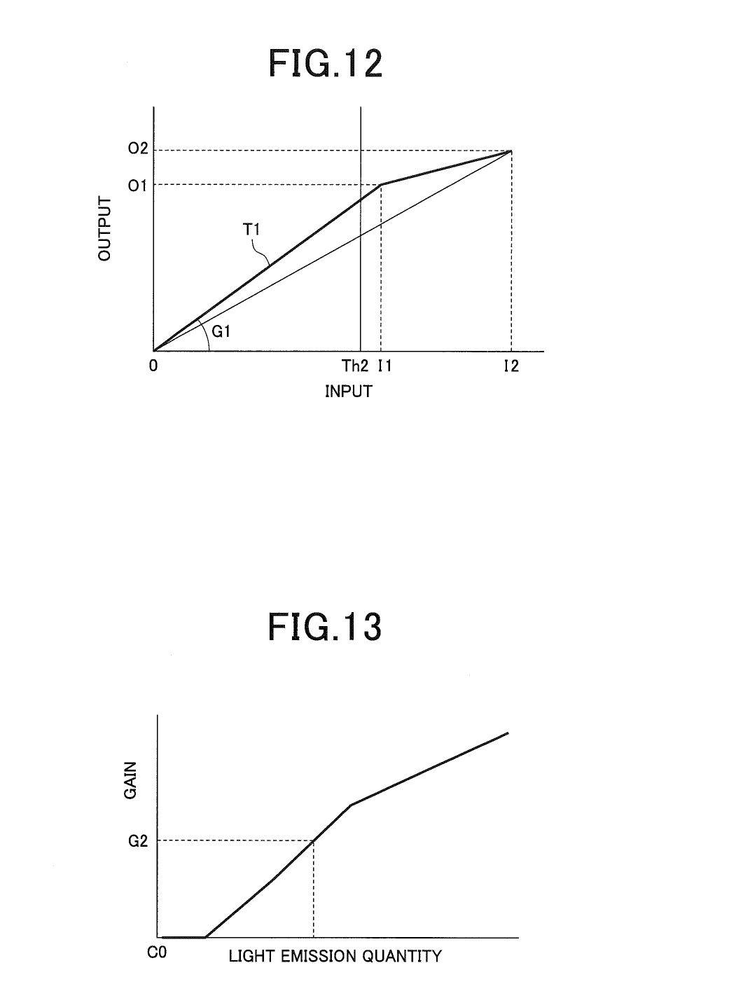

FIG. 12 is an explanatory diagram of stretching of the luminance of a video signal performed by the video signal luminance stretch portion, showing an example of setting the input/output characteristics of the video signal. As described above, the light emission detecting portion 1 generates a luminance (Y) histogram of an input video signal and determines the second threshold Th2 that defines a luminescence boundary, based on the average and standard deviation of the histogram. In the Y histogram, pixels belonging to an area equal to or higher in tone value than the threshold Th2 are considered to be pixels making up a light emission part. The video signal luminance stretch portion 6 executes video processing for stretching the video signal of the light emission part, based on the Y histogram.

At this time, for example, the input/output characteristics of the video signal is defined as the input/output characteristics of FIG. 12. In FIG. 12, the horizontal axis represents the input tone of the luminance Y of the video signal and the vertical axis represents the output tone corresponding to the input tone. Instead of defining the input/output characteristics of the video signal with the luminance Y, the input/output characteristics of an RGB signal may be defined. In the case of the RGB signal, a gain, which will be described below, is applied to each RGB signal and its input/output characteristics is defined. The maximum of the input/output tones is, for example, 255 tones when the video signal is expressed in 8 bits. In FIG. 12, T1 represents the input/output characteristics of the video signal having been subjected to a luminance stretching processing.

To set the input/output characteristics T1, an input tone point I1 is specified first. The point I1 is set at a given position determined arbitrarily in advance. The given position does not shift depending on the second threshold Th2. Therefore, when the point T1 is located closer to the low-tone side than the second threshold Th2 is, the point I1 represents the same value as represented by the second threshold Th2. The point I1 is equivalent to a characteristics change point of the present invention.

The output tone O1 to the input tone I1 is set in advance to a given value. For example, the output tone O1 is set to the value equivalent to 80% of the output tone maximum O2. According to the input/output characteristics T1, therefore, in an area in which the input tone ranges from 0 to the point I1, a gain G1 is give to the input video signal to stretch it so that the input tone at the point I1 corresponds to the output tone O1. The gain G1 can be expressed as the slope of the input/output characteristics T1. The gain G1 is determined by the position of the point I1 that determines the corresponding output tone.

For the maximum input tone I2, the maximum output tone O2 identical in tone value with the maximum input tone is output. In an area between the input tone I1 and the maximum input tone I2, the position of the output tone corresponding to the input tone I1 is connected to the position of the output tone corresponding to the maximum input tone I2 via a segment. In the area between the point I1 and the point I2, the output tone is increased gradually as the input tone increases under a condition where sufficient luminance stretching is performed at the point I1. Through this process, crushed white caused by the luminance stretching is prevented as much as possible to express tone property.

In this manner, the input/output characteristics T1 of FIG. 12 is defined. At this time, through stretching of the video signal, the video signal luminance of a light emission part is stretched and a non-light emission part with low tone is also stretched. To deal with this, the mapping portion 7 at the rear stage executes a tone mapping processing of reducing the video signal luminance of the non-light emission part.

### (Video Signal Luminance Stretch Processing 2)

FIG. 13 is an explanatory diagram of another example of stretching of the luminance of a video signal performed by the video signal luminance stretch portion. In the example 1 of FIG. 12, the point I1 representing a given output tone value is set according to the Y histogram of the video signal and the gain applied to the input video signal is set according to the point I1.

In this example, the light emission detecting portion 1 sets a gain for stretching a video signal, based on the value of a light emission quantity (score) detected according to a Y histogram or max RGB Ave.

As shown in FIG. 13, the video signal luminance stretch portion 6 defines in advance a relation between a light emission quantity and a gain. The video signal luminance stretch portion 6 makes an LUT according to the defined relation and determines a gain corresponding to a light emission quantity, using the LUT. Basically, the gain for stretching the video signal is determined to be larger as the light emission quantity becomes larger. For a given area in which the light emission quantity is small, the gain can be set to prevent a gain increase. This is because that a small light emission quantity creates less light emission part, in which case stretching the luminance of the video signal produces little effect.

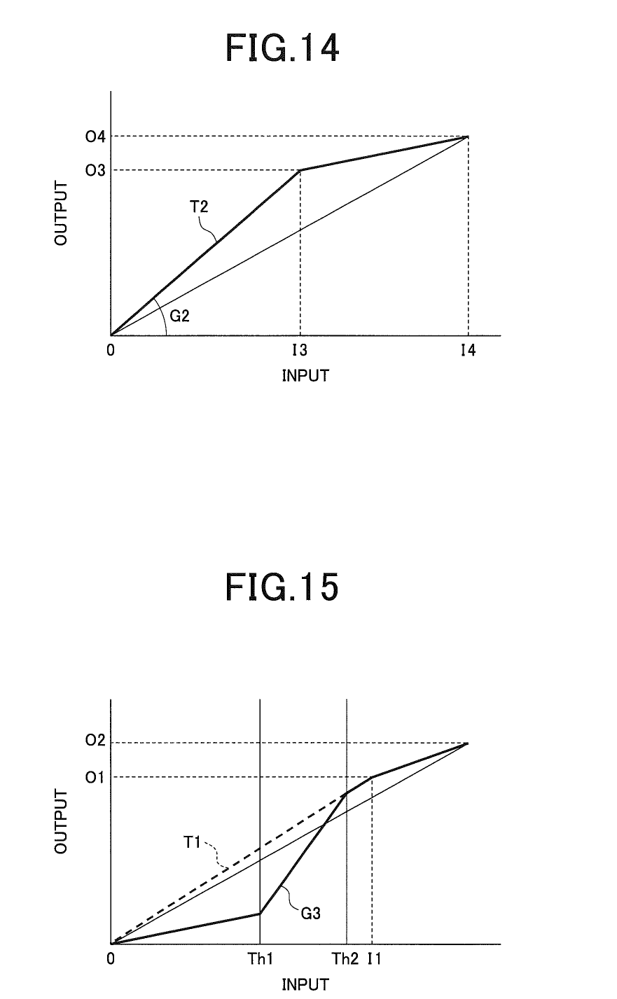

FIG. 14 depicts an example of setting the input/output characteristics of an input video signal when the input video signal is stretched by giving a gain thereto. Based on the relation of FIG. 13, the video signal luminance stretch portion 6 determines a gain according to a light emission quantity, and applies the gain to the video signal. For example, it is assumed that a gain G2 is determined based on the relation of FIG. 13.

In this case, as shown in FIG. 14, the determined gain G2 is applied to the input video signal in an area in which the input tone ranges from the minimum (0) to a given tone I3. The gain G2 is expressed as the slope of input/output characteristics T2 that results following the gain application.

The given tone I3 can be set arbitrarily. For example, an output tone O3 corresponding to the input tone 13 is set to a tone equivalent to 80% of the maximum tone O4. Then, when the gain G2 is applied to the video signal and the output tone reaches 80% of the maximum tone, the corresponding input tone is defined as the input tone I3. In an area in which the input tone ranges from the tone I3 to the maximum tone I4, the position of the output tone corresponding to the tone I3 is connected to the position of the output tone corresponding to the maximum tone I4 via a segment. In this manner, the input/output characteristics T2 of FIG. 14 are defined. The input tone I3 is equivalent to a characteristics switching point of the present invention.

At this time, through stretching of the video signal, the video signal luminance of a light emission part is stretched and a non-light emission part with low tone is also stretched. To deal with this, the mapping portion 7 at the rear stage executes signal processing to reduce the video signal luminance of the non-light emission part.

### (Mapping Processing 1)

As described above, the video signal luminance stretch portion 6 stretches the video signal based on the distribution state of the Y histogram or a detected light emission quantity. This signal stretching increases luminance in all tone areas of the input video signal, creating a condition where so-called black float occurs easily, thus leading to deteriorated image quality and insufficient contrast feeling.

The mapping portion 7 reduces the luminance of a non-light emission part by video signal processing. Through this processing, the luminance of the light emission part of the input video signal is stretched as the luminance of the non-light emission part is left as it is. Hence a contrast feeling is given to an image of which the light emission part is highlighted with an emphasized feeling of brightness.

FIG. 15 depicts an example of tone mapping generated by the mapping portion 7, showing an example of tone mapping that is performed when a video signal is stretched according to the position of the point I1 set on the Y histogram of the video signal by the luminance stretching processing 1 of FIG. 12. In FIG. 15, the horizontal axis represents the input tone of the video signal and the vertical axis represents the output tone. The input/output tones may be replaced with the luminance Y or RGB tone of the video signal. In the case of an RGB signal, a gain, which will be described below, is applied to each RGB signal and its input/output characteristics are defined.

An area equal to or higher in tone value than the second threshold Th2, which area is detected by the light emission detecting portion 1, is equivalent to a part of video that is regarded as a light emission part. The mapping portion 7 applies a compression gain to the part of the video signal other than the light emission part, the video signal being stretched in luminance by the video signal luminance stretch portion 6, thereby maps out characteristics with a reduced gain.

At this time, if a fixed compressed gain is applied uniformly to an area lower in tone value than the threshold Th2 representing a luminescence boundary to suppress the output tone, a feeling of oddness in tone property arises. To prevent this, tone mapping is performed in such a way that the first threshold Th1 is set and a gain G3 is set for an area lower in tone value than the threshold Th1 and that the points corresponding to the thresholds Th1 and Th2 are connected via a segment.

The gain G3 is used to compensatively reduce luminance equivalent to the sum of the amount of luminance stretching by the backlight luminance stretch portion 3 and the amount of luminance stretching by the video signal luminance stretch portion 6, and is set to a value for maintaining the tone of the input video signal on the screen.

It is assumed in this example that backlight luminance is stretched to b times the original. The reference based on which b times is determined is the backlight luminance at the point E1 of FIG. 11. B times, therefore, means that the original luminance at the point E1 is stretched by a factor of b. In this case, to compensatively reduce the amount of backlight luminance stretch of b times, a reduction rate of (1/b)^{γ} is necessary.

It is assumed that the amount of luminance stretching using the gain G1 by the video signal luminance stretch portion 6 is a times the original luminance. The reference based on which a times is determined is input/output characteristics in the case of the gain=1 (input tone=output tone). In this case, the rate of luminance reduction through video processing by the mapping portion 7 is 1/a times. Therefore, the gain G3 applied to the area smaller in tone value than the first threshold Th1 is determined to be (1/b)^{γ}×(1/a). With this gain G3, in the area lower in tone value than the first threshold Th1 out of the non-light emission part of the input video signal, screen luminance corresponding to the tone of the input video signal is maintained.

In tone mapping on the area higher in tone value than the second threshold Th2, the input/output characteristics stretched by the video signal luminance stretch portion 6 are used as they are. The characteristics change point (knee point) of the input/output characteristics at the input tone I1 set in the area higher in tone value than the second threshold Th2 is also maintained. As a result, in the light emission color area higher in tone value than the second threshold Th2, a light emission image with a feeling of brightness can be obtained by video signal stretching and backlight luminance stretching.

In the area between the thresholds Th1 and Th2, the position of the output tone corresponding to the first threshold Th1 that is lowered by the gain G3 is connected the position of the output tone corresponding to the second threshold Th2 via a segment. Through this processing, the tone mapping of FIG. 15 is obtained. At this time, the connected part between the thresholds Th1 and Th2 and the input tone I1, i.e., characteristics change point may be smoothed by smoothing a given range (e.g., connection points±Δ (Δ denotes a given value)) with a secondary function.

### (Mapping Processing 2)

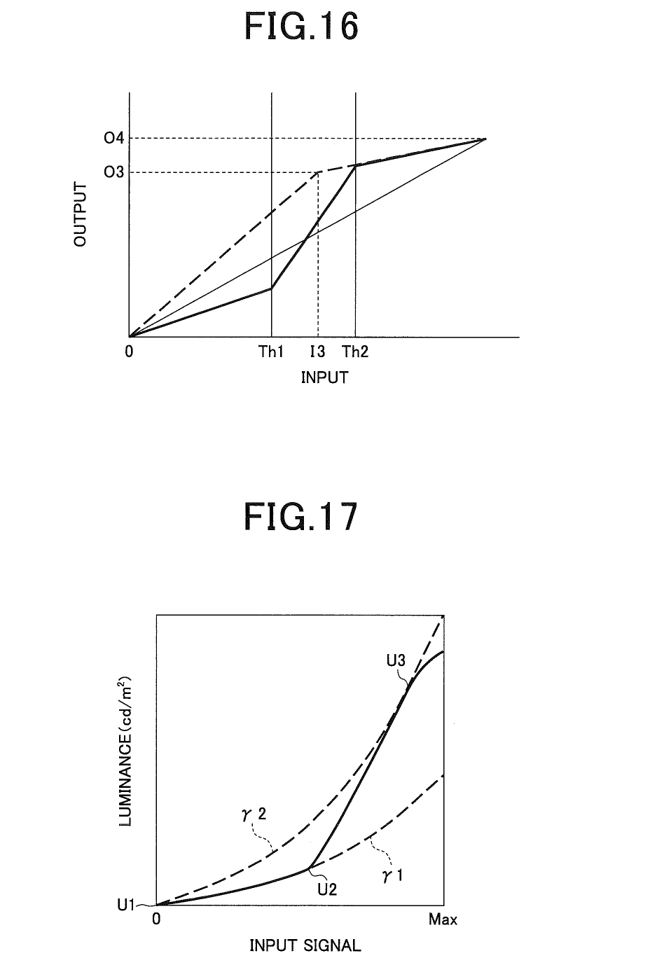

FIG. 16 depicts another example of tone mapping generated by the mapping portion 7, showing an example of tone mapping that is performed when a video signal is stretched, using a gain set based on the light emission quantity of the video signal, by the video signal luminance stretch process of FIG. 14. In FIG. 16, the horizontal axis represents the input tone of the video signal and the vertical axis represents the output tone. The input/output tones may be replaced with the luminance Y or RGB tone of the video signal. In the case of an RGB signal, a gain, which will be described below, is applied to each RGB signal and its input/output characteristics are defined.

In this example, in the same manner as in the example of the mapping processing 1 of FIG. 15, a compression gain is applied to a part of a video signal other than a light emission part, the video signal being stretched in luminance by the video signal luminance stretch portion 6, to reduce the gain of the video signal. In this case, in the same manner as in the example of FIG. 15, tone mapping is perform in such a way that the first threshold Th1 is set and the gain G3 is set for an area smaller in tone value than the threshold Th1 and that the points corresponding to the thresholds Th1 and Th2 are connected via a segment.

The gain G3 is used to compensatively reduce luminance equivalent to the sum of the amount of luminance stretching by the backlight luminance stretch portion 3 and the amount of luminance stretching by the video signal luminance stretch portion 6. When backlight luminance is stretched to b times the original and the amount of luminance stretching using the gain G2 by the video signal luminance stretch portion 6 is a times the original luminance, the gain G3 applied to the area smaller in tone value than the first threshold Th1 is determined to be (1/b)^{γ}×(1/a). With this gain G3, in the area lower in tone value than the first threshold Th1 out of the non-light emission part of the input video signal, screen luminance corresponding to the tone of the input video signal is maintained.

In tone mapping on an area higher in tone value than the second threshold Th2, the input/output characteristics stretched by the video signal luminance stretch portion 6 are used as they are. As a result, in the light emission color area higher in tone value than the second threshold Th2, a light emission image with a feeling of brightness can be obtained by video signal stretching and backlight luminance stretching.

In the area between the first threshold Th1 and the second threshold Th2, the position of the output tone corresponding to the first threshold Th1 that is lowered by the gain G3 is connected the position of the output tone corresponding to the second threshold Th2 via a segment. Through this processing, the tone mapping of FIG. 16 is obtained. The input tone I3, i.e., characteristics change point (knee point) set by the video signal luminance stretch portion 6 is not maintained if the input tone I3 is smaller than the second threshold Th2, in which case the characteristics switching point is absorbed into the segment connecting the output tone position corresponding to the threshold Th1 to the output tone position corresponding to the threshold Th2. As a result, a new characteristics change point is set at the output tone position corresponding to the second threshold Th2. At this time, the connected part between the thresholds Th1 and Th2 may be smoothed by smoothing a given range (e.g., connection points±Δ (Δ denotes a given value)) with a secondary function.

FIG. 17 depicts an example of a state where screen luminance is stretched. In FIG. 17, the horizontal axis represents the tone value of an input video signal and the vertical axis represents the screen luminance (cd/m²) of the display portion 9.

U1 denotes the minimum tone value, U2 denotes a tone value at the first threshold Th1, and U3 denotes a tone value at the second threshold Th2. For the case of input tone values within the area between U1 and U2, tone mapping of the video signal is performed to reduce luminance by an amount equivalent to an increment in the screen luminance resulting from stretching of the backlight luminance and stretching of the video signal. As a result, screen display is made with the screen luminance represented by a first γ curve (γ1) in the area between U1 and U2. The first γ curve (γ1) represents, for example, standard luminance that makes the screen luminance 450 cd/m² when the tone value is the maximum. In this case, even when the amount of stretching of the backlight luminance is limited according to the result of black detection by the black detection portion 10, tone mapping is performed to reduce luminance by an amount equivalent to an increment in the screen luminance resulting from stretching of the backlight luminance to which the black detection result has been applied and stretching of the video signal.

If dark video with low tone is displayed with its luminance being increased, the deterioration of image quality, such as lower contrast and black float, results. For this reason, the luminance is reduced by the amount equivalent to the amount of stretching of the backlight luminance and the amount of stretching of the video signal through video signal processing to prevent an increase in the screen luminance. The γ curve in the area between U1 and U2 does not need to be the same as the above standard first γ curve (γ1). The γ curve that creates a difference between the γ curve and a screen luminance curve including a stretched portion in a light emission part is applicable, and such a γ curve can be set by properly adjusting the gain G3.

In the area between U2 and U3, as a result of tone mapping on the area between the thresholds Th1 and Th2, the screen luminance curve separates from the first γ curve (γ1) and keeps rising as the input tone increases, and then reaches a second γ curve (γ2) near a point S3 corresponding to the second threshold Th2. Subsequently, the screen luminance curve increases at a lower rate (with a gradual slope) to reach the maximum input tone. The second γ curve (γ2) is given by expressing the screen luminance resulting from stretching of the video signal using the gain G1 of FIG. 12 or gain G2 of FIG. 14, in the form of a γ curve. By reducing the screen luminance increase rate in the high-tone area higher in tone value than the point U3, tone crushing in the high-tone area cause by luminance stretching is prevented to maintain sound tone expression as much as possible. Hence highly quality video display with a feeling of brightness of the high-tone area and contrast feeling can be achieved.

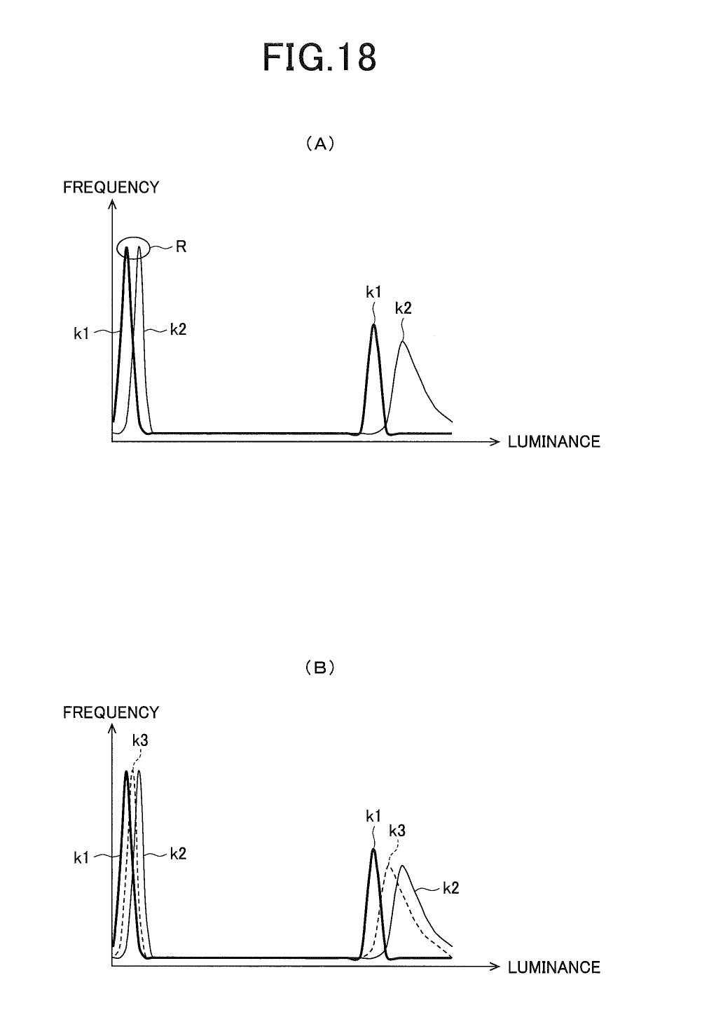

FIG. 18 is explanatory diagrams of an effect of a luminance stretching processing according to the present invention, showing examples of screen conditions before and after the luminance stretching processing. FIG. 18 depicts luminance on the display screen in which the result of video signal processing and backlight luminance stretch is reflected, and the frequency of pixels corresponding to the luminance.

FIG. 18(A) depicts an example for comparison in which luminance stretching limitation according to black detection is not performed. In FIG. 18(A), k1 denotes a screen luminance histogram that results when an input video signal not subjected to the luminance stretching processing yet is displayed, and k2 denotes a screen luminance histogram that results when tone mapping on the input video signal of the histogram k1 is performed through the above luminance stretching and mapping processing.

In this example, the input video signal includes many pixels in the low-tone area with tone close to black and many pixels also in the high-tone area larger in tone value than the threshold Th2. In other words, the input video signal creates an image such that a bright part considered to be a light emission part is present in a nearly black, dark screen.

According to the above luminance stretching processing 1 and mapping processing 1, the second threshold Th2 is set based on the luminance histogram of the input video signal, a luminance increase by a gain is performed in the area between the point of the lowest tone and the point I1 equal to or higher than tone value than the threshold Th2, and luminance in the low-tone area lower in tone value than the threshold Th1, which low-tone area is equivalent to the non-light emission part, is reduced through the mapping processing. According to the luminance stretching processing 2 and mapping processing 2, a gain is determined based on a light emission quantity detected from the input video signal, the determined gain is applied to the low-tone area to increase luminance in the area, and luminance in the low-tone area lower in tone value than the threshold Th1, which low-tone area is equivalent to the non-light emission part, is reduced through the mapping processing. At this time, the luminance of the backlight is stretched according to the detected light emission quantity.

According to the screen luminance histogram k2 obtained by these processes, in the high-luminance area representing a luminescent color, the luminance of video shifts further to the high-luminance side to provide bright video with a feeling of brightness. However, in the non-light emission part with low tone close to black, the tone of the input video signal is already close to black, that is, the tone value of the video signal is sufficiently low, so that the luminance cannot be reduced further through signal processing. Stretching of the backlight luminance causes the screen luminance to increase. As a result, the luminance of pixels in the area with tone close to black shifts to the high-luminance side, developing black float, as indicated by R in FIG. 18(A).

FIG. 18(B) depicts a screen luminance histogram k3 that results when stretching of the backlight luminance is limited according to the amount of black detected by the black detection portion. For comparison, FIG. 18(B) also shows the screen luminance histograms k1 and k2 of FIG. 18(A).

According to the embodiment of the present invention, stretching of the backlight luminance determined according to a light emission quantity is limited further according to the amount of black detected by the black detection portion. For example, as indicated by the histogram k1, in the case of an image such that a bright part considered to be a light emission part is present in a nearly black, dark screen, a certain amount of black is detected by the black detection portion. Therefore, an enhancement proportion is reduced according to the amount of detected black (black detection score) to limit luminance stretching. An example of a screen luminance histogram obtained through such a process is the histogram k3.

This histogram k3 demonstrates that compared to the screen luminance histogram k2 in the case of not limiting the amount of luminance stretching according to black detection, a shift in the screen luminance to the high-tone side is suppressed to prevent an image quality deterioration due to black float.

The above examples are examples of states of video when fine results are obtained. The above either processing is executed to perform stretching of the backlight luminance, stretching of the video luminance, and tone mapping which improve a contrast feeling and increase a feeling of brightness of a bright part, thereby allows highly quality video expression. By limiting and adjusting stretching of the backlight luminance according to the result of black detection by the black detection portion, black float of video with many black areas is suppressed to allow display of highly quality video.

### Second Embodiment

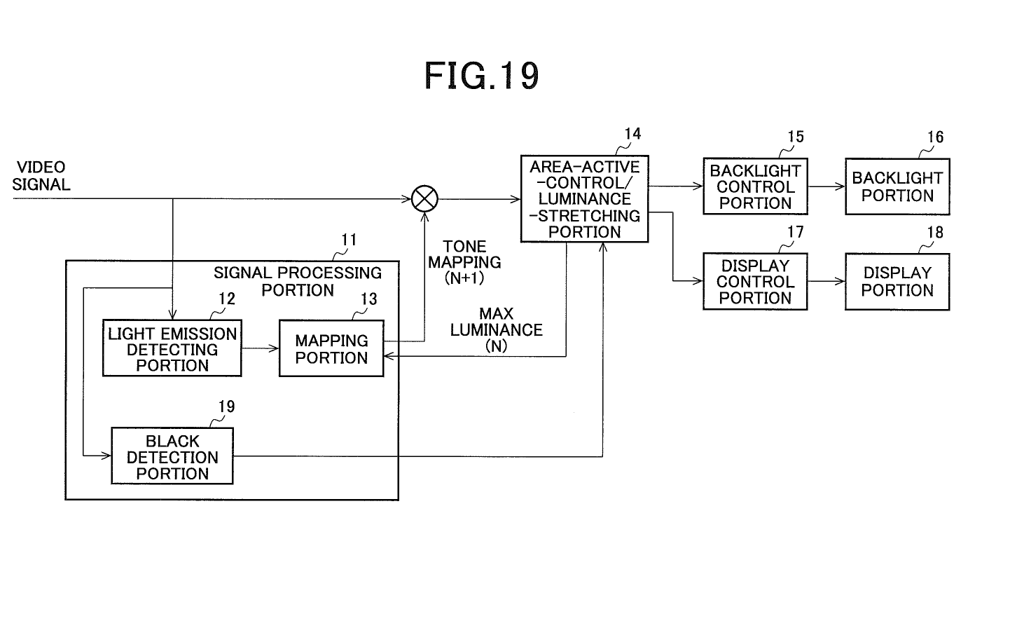

FIG. 19 is an explanatory diagram of a second embodiment of the video display device according to the present invention, showing a principle part of the video display device. The video display device has a configuration for performing image processing on an input video signal and displaying video, and can be applied to a television receiving device, etc.

A video signal separated from a broadcasting signal or an incoming video signal from an external apparatus is input to a signal processing portion 11 and to an area-active-control/luminance-stretching portion 14. At this time, tone mapping generated by a mapping portion 13 of the signal processing portion 11 is applied to the video signal to be input to the area-active-control/luminance-stretching portion 14, after which the video signal subjected to the tone mapping is input to the area-active-control/luminance-stretching portion 14.

A light emission detecting portion 12 of the signal processing portion 11 generates a histogram based on a feature quantity related to the brightness of the input video signal, for each frame and detects a light emission part. The light emission part is determined by the average and standard deviation of the histogram and is detected as a relative value for each histogram.

Based on the feature quantity of the input video, a black detection portion 19 of the signal processing portion 11 detects the amount of black display for each frame. A specific processing of black detection is the same as the black detection processing of the first embodiment.

The mapping portion 13 generates tone mapping, using information of a detected light emission part and max luminance output from the area-active-control/luminance-stretching portion 14, and applies the tone mapping to the input video signal.

According to the input video signal, the area-active-control/luminance-stretching portion 14 divides an image created by the video signal into given areas and extracts the maximum tone value of the video signal from each divided area. The area-active-control/luminance-stretching portion 14 then calculates the lighting rate of the backlight portion 16, based on the maximum tone value. The lighting rate is determined for each area of the backlight portion 16 corresponding to each video divided area. The backlight portion 16 is composed of multiple LEDs, thus enabling luminance control for each divided area.

The lighting rate at each area of the backlight portion 16 is determined based on a predetermined calculation formula. Basically, the lighting rate is calculated so that the luminance of the LED is maintained without allowing its decline in a bright area with the high maximum tone value while the luminance of the LED is lowered in a dark area with low tone.

Based on the lighting rate at each area, the area-active-control/luminance-stretching portion 14 calculates the average lighting rate of the backlight portion 16 as a whole, and calculate the amount of luminance stretching at the backlight portion 16 according to the average lighting rate, using a given calculation formula. Hence the maximum luminance value (max luminance) that can be taken in areas in the screen is obtained. This obtained max luminance is adjusted based on the result of black detection by the black detection portion 19, and the adjusted max luminance is output to the mapping portion 13 of the signal processing portion 11.

The area-active-control/luminance-stretching portion 14 sends the max luminance adjusted according to the result of black amount detection back to the signal processing portion 11 and reduces the luminance by the amount equivalent to the amount of luminance stretching at the backlight portion 16. At this time, luminance stretching is performed on the whole of the backlight portion 16 and the luminance reduction by video signal processing is performed on a part considered to be a non-light emission part other than a light emission part. Hence the screen luminance of the light emission part only is increased, which allows video expression with high contrast, thus improving image quality.

The area-active-control/luminance-stretching portion 14 outputs control data for controlling the backlight portion 16 to a backlight control portion 15, which controls the light-emission luminance of the LEDs of the backlight portion 16 for each divided area, based on the incoming control data. The luminance of the LEDs of the backlight portion 16 is controlled through pulse width modulation (PWM), and may be adjusted to a desired luminance value through current control or a combination of current control and PWM.

The area-active-control/luminance-stretching portion 14 outputs control data for controlling the display portion 18 to the display control portion 17, which controls the display operation of the display portion 18 based on the incoming control data. The display portion 18 equips a liquid crystal panel that is illuminated by the LEDs of the backlight portion 16 to display an image.

According to this embodiment, the control portion of the present invention controls the backlight portion 16 and the display portion 18, and is equivalent to the signal processing portion 11, area active control/luminance stretching portion 14, backlight control portion 15, and display control portion 17.

When the above display device is configured as a television receiving device, the television receiving device has a means that tunes a broadcasting signal received by an antenna to a selected channel and that generates a reproduction video signal by demodulating and decoding the signal. The television receiving device properly executes given image processing on the reproduction video signal and inputs the processed signal as the video signal of FIG. 19. Hence the received broadcasting signal is displayed on the display portion 18. The present invention provides the display device and the television receiving device having the display device.

Examples of processing by the component portions of this embodiment having the above configuration will hereinafter be described in detail.

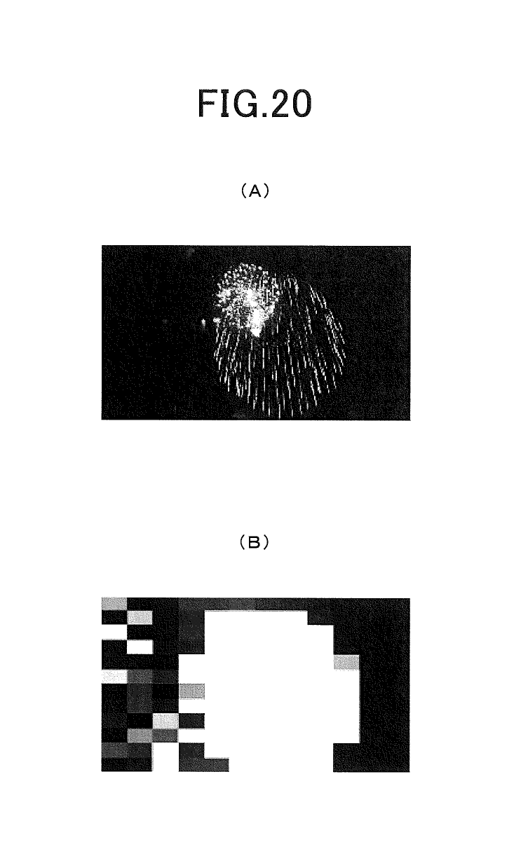

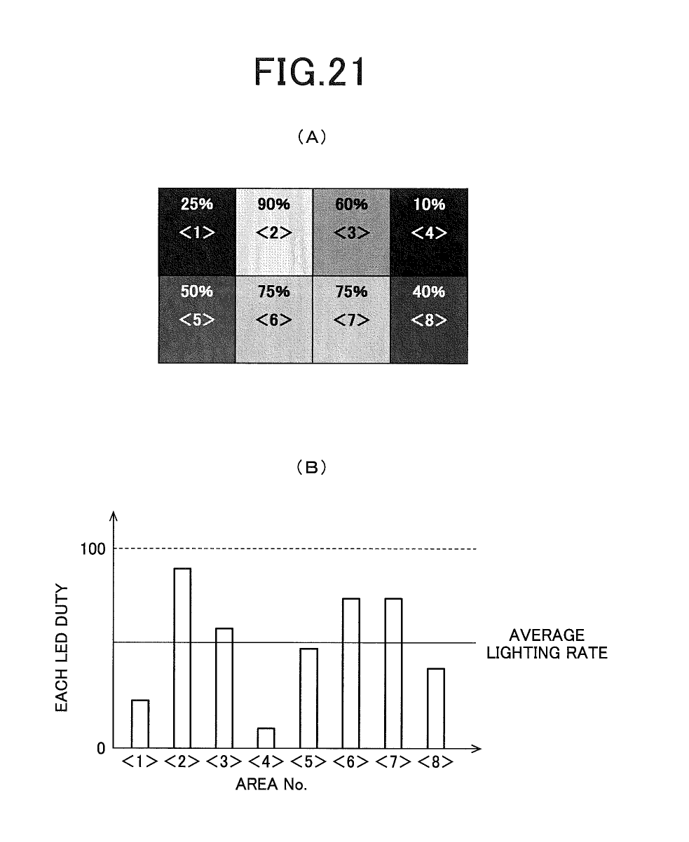

The area-active-control/luminance-stretching portion 14 divides an image into given multiple areas and controls the light-emission luminance of the LEDs corresponding to divided areas, for each area. FIGS. 20 and 21 are explanatory diagrams of a light emission area control processing by the area-active-control/luminance-stretching portion 14. Area active control executed in this embodiment is a process of dividing an image into given multiple areas and controlling the light-emission luminance of the LEDs corresponding to divided areas, for each area.

In this example, based on an input video signal, the area-active-control/luminance-stretching portion 14 divides one frame of video into predetermined multiple areas and extracts the maximum tone value of the video signal for each divided area. For example, such video as indicated in FIG. 20(A) is divided into predetermined multiple areas. In this example, the maximum tone value of the video signal for each area is extracted. In another example, a statistical value different from the maximum tone value, such as tone average of the video signal, may be used. An example of extraction of the maximum tone value will hereinafter be described.

The area-active-control/luminance-stretching portion 14 determines an LED lighting rate in each area according to the extracted maximum tone value. FIG. 20(B) depicts a result of the determined LED lighting rate in each area. On a bright part with the high video signal tone, the lighting rate of the LED is raised to perform bright display. This process will be described in detail.

FIG. 21 depicts an example of a result of extraction of the maximum tone value for each of divided areas of one frame. For simpler description, FIG. 21 shows an example in which one frame of screen is divided into eight areas (areas <1> to <8>). FIG. 21(A) depicts a lighting rate in each area (area <1> to area <8>), and FIG. 21(B) depicts a lighting rate in each area and an average lighting rate over the whole screen. In this example, from the maximum tone value in each area, the LED lighting rate of the backlight in each area is calculated. The lighting rate can be expressed in terms of, for example, the drive duty of the LED. In such a case, the maximum lighting rate means 100% duty.

When the LED lighting rate in each area is determined, in a dark area with the small maximum tone value, the lighting rate is lowered to reduce the luminance of the backlight. For example, when the video tone values ranging from 0 to 255 are expressed in 8-bit data, if the maximum tone value is 128, the backlight lighting rate is reduced to (1/(255/128))^{2.2}=0.217 (21.7%).

In the examples of FIG. 21, the backlight lighting rate is determined to be within a range of 10 to 90% for each area. This indicates one example of a lighting rate calculation method. Basically, the lighting rate in each area is calculated using a calculation formula defined in advance so that the backlight luminance is not reduced in a bright area with high tone but is reduced in a dark area with low tone.

Then, backlight lighting rates in respective areas each calculated from the maximum tone value of the video signal is averaged to calculate the average lighting rate of the backlight in one frame. In this example, the average lighting rate is calculated at an average lighting rate level shown in FIG. 21(B).

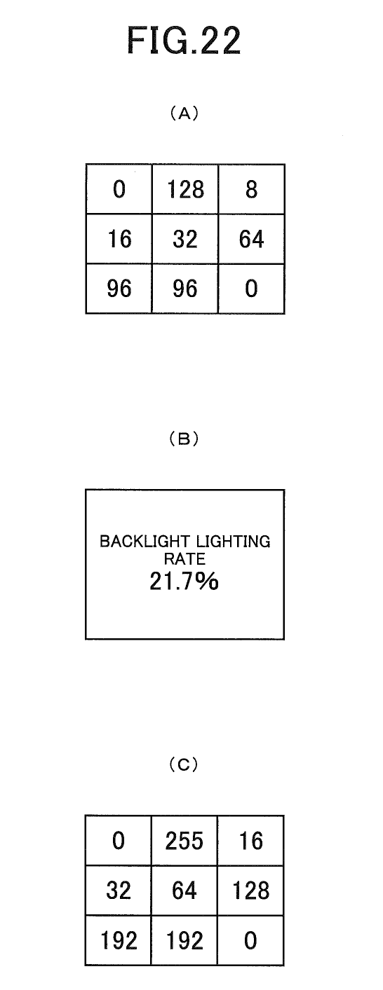

FIG. 22 is explanatory diagrams for explaining an average lighting rate determination processing in detail. As described above, when the LED lighting rate in each area is determined, for a dark area with the small maximum tone value, the lighting rate is lowered to reduce the backlight luminance. The actual lighting rate in each area is determined such that an intended tone to be displayed is displayed accurately as the LED duty is kept low as much as possible. To keep the LED duty as low as possible and at the same time, accurately display the intended tone without causing tone crushing, an LED duty (temporary lighting duty) is set as an LED duty that allows the maximum tone in the area to be displayed and that keeps the LED duty as low as possible. Based on this set LED duty, the tone of the display portion 9 (LCD panel) is determined.

For example, a case is described where the video tone values ranging from 0 to 255 are expressed in 8-bit data and the tone values of multiple pixels in one area of divided areas of FIG. 21(A) are indicated as FIG. 22(A). In this case, nine pixels correspond to one area. A group of pixel tone values shown in FIG. 22(A) indicate that the maximum tone value is 128, in which case, as shown in FIG. 22(B), the lighting rate of the backlight for this one area is reduced to (1/(255/128))^{2.2}=0.217 (21.7%).

The area-active-control/luminance-stretching portion 14 determines such a lighting rate as one example of lighting rate, and calculates a tone value for each pixel displayed by the display portion 9 while taking account of a lighting rate in an area in which the pixel is included. For example, when an intended tone value to be displayed is 96, it follows from calculation of 96/(128/255)=192 that the corresponding pixel should be expressed using a tone value of 192. Each tone value for pixel display is calculated for each pixel tone value of FIG. 22(A) in the same manner, and the result of calculation is shown in FIG. 22(C).

The actual luminance of the backlight portion 16 is further stretched and increased based on the maximum luminance value determined according to the average lighting rate. The original reference luminance is, for example, the luminance that determines the screen luminance for the maximum tone value to be 550 (cd/m²). The reference luminance is not limited to this case but may be set properly.

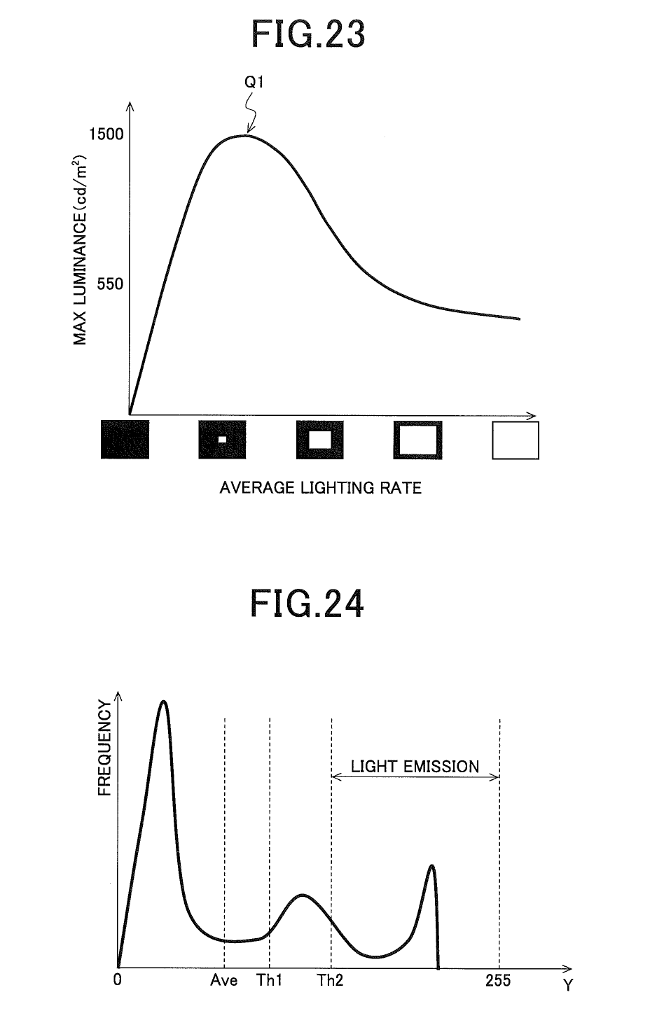

FIG. 23 is an explanatory diagram of a process of determining the amount of stretching by the area-active-control/luminance-stretching portion.

As described above, the area-active-control/luminance-stretching portion 14 calculates the average lighting rate over the whole screen from a lighting rate in each area determined according to the maximum tone value, etc. An increase in the number of areas with a high lighting rate, therefore, leads to an increase in the average lighting rate over the whole screen.

The maximum luminance to be taken (max luminance) is determined based on a relational curve indicated in FIG. 23. In FIG. 23, the horizontal axis represents the lighting rate of the backlight (window size) and the vertical axis represents the screen luminance (cd/m²) for the max luminance. The average lighting rate can be expressed as a ratio between a lighting area with a lighting rate of 100% (window area) and a lights-out area with a lighting rate of 0%. When no lighting area is present, the average lighting rate is zero. The average lighting rate increases as the window of the lighting area glows larger, and reaches 100% when the lighting area glows into full-lighting area.

This maximum luminance (max luminance) represents a basic luminance value before it is subjected to limitation of the amount of stretching based on black detection. When limitation of the amount of stretching according to the result of black detection is not performed, the max luminance is determined based on the relational curve of FIG. 22, and the backlight luminance is stretched according to the determined max luminance.

In FIG. 23, the max luminance when the backlight is fully lighted up (average light rate 100%) is assumed to be, for example, 550 (cd/m²). According to this embodiment, the max luminance is increased as the average lighting rate decreases. At this time, a pixel with a tone value of 255 (in the case of 8-bit expression) produces the highest screen luminance on the screen, thus providing the maximum screen luminance (max luminance) that can be taken. For the same average lighting rate, therefore, the screen luminance is not increased to the max luminance depending on the tone value of a pixel that produces the luminance.

When the average lighting rate is Q1, the max luminance reaches its maximum, at which the maximum screen luminance is 1500 (cd/m²). This means that when the average lighting rate is Q1, the maximum screen luminance that can be taken is stretched from the max luminance 550 (cd/m²) at the time of full lighting to 1500 (cd/m²). Q1 is set at a position at which the average lighting rate is relatively low. In other words, the backlight luminance is stretched to its maximum of 1500 (cd/m²) for a generally dark screen with the relatively low average lighting rate and a high-tone peak present on a part of the screen. In the area between the point of average lighting rate Q1 at which the max luminance takes its maximum and the point of average lighting rate 0 (all black), the max luminance value is reduced gradually.

The max luminance value determined according to the average lighting rate is limited and adjusted according to the result of black amount detection by the black detection portion 19 of the signal processing portion 11. The black detection portion 19 detects the amount of black for each frame according to the feature quantity of the video signal. Any one of the above black detection processing 1 to 3 of the first embodiment can be used as a method of detecting the amount of black, and is therefore referred to as the method to avoid repeated explanations. By executing the black detection processing, the black detection portion 10 outputs an enhancement proportion for limiting the amount of stretching.

The area-active-control/luminance-stretching portion 14 receives the incoming enhancement proportion from the black detection portion 19 and determines max luminance to be actually applied to the backlight. Specifically, the basic max luminance value determined according to the average lighting rate based on the characteristics curve of FIG. 23 is V, the original reference luminance in the case of not performing luminance stretching is X, the enhancement proportion output from the black detection portion 10 is W, and the max luminance finally applied to the backlight is Z, the final max luminance is determined by the following equation.

Max luminance Z=(V−X)×W+X (8)

When the amount of black is large and the enhancement proportion is close to zero, the max luminance is determined to be close to the reference luminance (e.g., 550 cd/m²). In this manner, when the amount of black is large, stretching of the backlight luminance is limited to prevent black float so that a highly quality image is displayed.

Then, a video signal input to the area-active-control/luminance-stretching portion 14 is subjected to tone mapping generated by signal processing by the signal processing portion 11, which will be described below, so that the video signal with its low-tone area subjected to a gain decrease is input. As a result, in a non-light emission area with low tone, the luminance of the video signal is reduced by the amount equivalent to the amount of stretching of the backlight luminance. Hence screen luminance is enhanced only in the light emission area, which increases a feeling of brightness.

The area-active-control/luminance-stretching portion 14 adjusts the basic max luminance value determined from the average lighting rate of the backlight according to the curve of FIG. 23, using the enhancement proportion detected by the black detection portion 19, and outputs the adjusted max luminance to the mapping portion of the signal processing portion 11. The mapping portion 13 performs tone mapping using the max luminance output from the area-active-control/luminance-stretching portion 14.

The signal processing portion 11 will be described.

A light emission detecting portion 12 of the signal processing portion 11 detects a light emission part from a video signal. In this example, the light emission detecting portion 12 executes a process of detecting a light emission part in the same manner as in the first embodiment.

FIG. 24 depicts an example of a Y histogram generated from the luminance signal Y of an input video signal. The light emission detecting portion 12 integrates the number of pixels for each luminance tone to generate the Y histogram, for each frame of the input video signal. In FIG. 24, the horizontal axis represents the tone value of the luminance Y and the vertical axis represents the number of pixels (frequency) integrated for each tone value. The luminance Y is one example of the video feature quantity for generating the histogram. A different example of the feature quantity is the RGB Max value or CMI described in the first embodiment, which may be used as the feature quantity to generate the histogram. In this example, a light emission part is detected with respect to the luminance Y.

When the Y histogram is generated, the average (Ave) and the standard deviation (σ) are calculated from the Y histogram, and two thresholds (first threshold Th1 and second threshold Th2) are calculated using the average and standard deviation. The first and second thresholds Th1 and Th2 can be determined by the same calculation as performed in the first embodiment.

The second threshold Th2 is a threshold that defines a luminescence boundary. On the Y histogram, pixels included in the area equal to or higher in tone value than the threshold Th2 are considered to be pixels representing a light emission part in execution of the luminescence detection processing.

The second threshold Th2 is defined as

Th2=Ave+Nσ Eq. (9)

where N denotes a given constant.

The first threshold Th1 is set for suppressing a feeling of oddness in tone in an area smaller in tone value than the threshold Th2 and is defined as

Th1=Ave.+Mσ Eq. (10)

where M denotes a given constant and M<N is satisfied.

The first and second thresholds, Th1 and Th2 detected by the luminance detecting portion 12 are output to the mapping portion 13 and used to generate tone mapping.

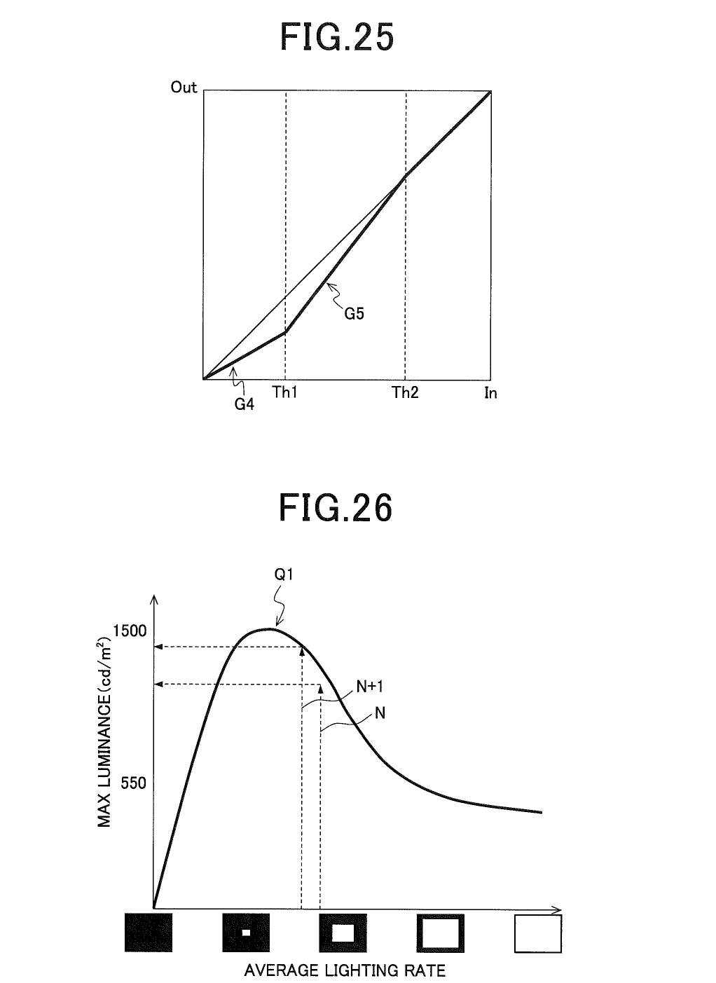

FIG. 25 depicts an example of tone mapping generated by the mapping portion 13. In FIG. 25, the horizontal axis represents the input tone of luminance of the video and the vertical axis represents the output tone of the same. Pixels included in the area equal to or larger in tone value than the threshold Th2 detected by the luminance detecting portion 12 represent a light emission part of the video, and a compression gain is applied to the part of the video other than the light emission part to perform a gain decrease. At this time, if a fixed compressed gain is applied uniformly to the area smaller in tone value than the threshold Th2 representing the luminescence boundary to suppress the output tone, a feeling of oddness in tone property arises. To prevent this, the light emission detecting portion 12 sets the first threshold Th1, and tone mapping is performed in such a way that a gain G4 is set for the area smaller in tone value than the threshold Th1 and that a gain G5 is set so that the points corresponding to the thresholds Th1 and Th2 are connected via a segment.

A gain setting method will be described.

To the mapping portion 13, the max luminance value from the area-active-control/luminance-stretching portion 14 is input. As described above, this max luminance value is given by adjusting the maximum luminance (max luminance) determined from the average lighting rate of the backlight, based on the detection result from the black detection portion 19. This value is input, for example, as the value of backlight duty.

The gain G4 is applied to the area smaller in tone value than the threshold Th1, and is set as

G4=(Ls/Lm)^{1/7} Eq. (11)

where Ls denotes the reference luminance (reference luminance in the case of not stretching the backlight luminance, e.g., luminance that determines the maximum screen luminance to be 550 cd/m²), and Lm denotes the max luminance output from the area-active-control/luminance-stretching portion 14. Hence the gain G4 applied to the area smaller in tone value than the threshold Th1 reduces the output tone of the video signal by an amount equivalent to an increment in the screen luminance caused by stretching of the backlight luminance.

Tone mapping performed on the area equal to or larger in tone value than the threshold Th2 is defined as f(x)=x, which means input tone=output tone, in which case the processing for reducing the output tone is not executed. In the area between the first threshold Th1 and the second threshold Th2, the output tone corresponding to the threshold Th1 that is reduced by the gain G4 is connected to the output tone corresponding to the threshold Th1 is connected via a segment.

Hence the gain G5 is determined as

G5=(Th2−G4×Th1)/(Th2−Th1) Eq. (12)

Through the above processing, the tone mapping of FIG. 25 is obtained. At this time, the connected part between the thresholds Th1 and Th2 should preferably be smoothed by smoothing a given range (e.g., connected part±Δ (Δ denotes a given value)) with a secondary function.

The tone mapping generated by the mapping portion 13 is applied to the input video signal. As a result, the video signal with its output in the low-tone area being suppressed based on the amount of stretching of the backlight luminance is input to the area-active-control/luminance-stretching portion 14.

FIG. 26 is an explanatory diagram of max luminance output from the area-active-control/luminance-stretching portion 14.

The area-active-control/luminance-stretching portion 14 receives the incoming video signal to which the tone mapping generated by the tone mapping portion 13 is applied, and performs area active control based on the video signal to determine basic max luminance based on an average lighting rate, and then applies the result of black amount detection by the black detection portion 19 to the basic max luminance to adjust the max luminance.

A signal frame at this point is assumed to be N frame. The max luminance value at the N frame is adjusted by the black detection portion 19 and is output to the mapping portion 13 of the signal processing portion 11. The mapping portion 13 generates the tone mapping of FIG. 25 using the max luminance value at the N frame, and applies the generated tone mapping to a video signal at an N+1 frame.

In this manner, according to this embodiment, the max luminance based on the average lighting rate under area active control is fed back to be used for tone mapping on the next frame. Based on the max luminance determined at the N frame, the mapping portion 13 applies the gain (gain G4) for reducing video output, to the area smaller in tone value than the first threshold Th1. The mapping portion 13 applies the gain G5 for connecting the threshold Th1 to the threshold Th2 via a segment, to the area between the threshold Th1 and the threshold Th2, thereby reduce video output in the area between the threshold Th1 and the threshold Th2.

At the N frame, the gain for reducing video output is applied, except for the case of not performing luminance stretching at all because of a large amount of black detection. As a result, in the area of a high lighting rate in which the average lighting rate is equal to or higher then Q1, the maximum tone value for each area decreases to creates a tendency of a drop in the lighting rate at the N+1 frame, which leads to a tendency of an increase in the max luminance at the N+1 frame. As a result, the amount of stretching of the backlight luminance further increases, which creates a tendency of an increase in a feeling of brightness of the screen. This tendency, however, is not observed in the area in which the lighting rate is lower than Q1, and the tendency reverse to that tendency results in the area.

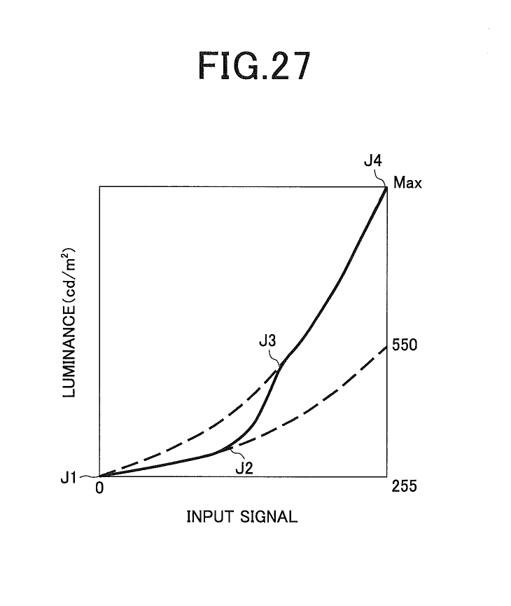

FIG. 27 depicts a state of enhancement of screen luminance through a process by the area-active-control/luminance-stretching portion 14. In FIG. 27, the horizontal axis represents the tone value of an input video signal and the horizontal axis represents the screen luminance (cd/m²) of the display portion 18.

J2 and J3 represent the positions of the tone values at the first and second thresholds Th1 and Th2 used by the light emission detecting portion 12. As described above, in the area equal to or larger in tone value than the second threshold Th2 detected by the light emission detecting portion 12, the signal processing of reducing the output tone of the video signal according to the amount of stretching of the backlight luminance is not performed. As a result, in the area between J3 and J4, the input video signal is expressed in its enhanced form as a γ curve that follows max luminance determined under area active control. For example, in the case of the max luminance being 1500 (cd/m²), when the input video signal takes its maximum tone value (255), the screen luminance is 1500 (cd/m²). The max luminance in this case is given by limiting and adjusting the basic max luminance, which is determined according to the average lighting rate determined based on the video signal, according to the result of the black detection processing.

On the other hand, for the input gray level values from J1 to J2, as above, the first gain G1 is applied to the video signal such that the amount of the screen luminance increased by the luminance stretching of the backlight is reduced, and therefore, the screen display is executed according to the γ-curve based on the reference luminance. This is because the mapping portion 13 suppresses the output value of the video signal into a range lower than the threshold value Th1 (corresponding to J2) corresponding to the amount of the luminance stretching, according to the Max luminance determined by the area-active-control/luminance-stretching portion 14. From J2 to J3, the screen luminance transitions according to the tone mapping of Th1 to Th2.

When the Max luminance is increased, the difference in the screen luminance direction is increased between the curve based on the reference luminance from J1 to J2 and the curve based on the Max luminance from J3 to J4. As above, the curve based on the reference luminance is the γ-curve with which the screen luminance having the maximal gray level value is the reference luminance acquired when the backlight luminance is not stretched (the screen luminance having the maximal gray level value is 550 cd/m² as an example). The curve based on the Max luminance is the γ-curve with which the screen luminance having the maximal gray level value is the Max luminance determined by the area-active-control/luminance-stretching portion 14.

In this manner, the screen luminance is controlled with the reference luminance for the input video signal to be at the zero gray level (J1) to J2. When the low-gray level and dark video is displayed with increased luminance, the quality level degradation is caused such as reduction of the contrast and the misadjusted black level, and therefore, any increase of the screen luminance is prevented by suppressing the luminance by the video signal processing by the amount of the luminance stretching of the backlight.

The area in which the input video signal tone value is equal to or larger than the tone value at J3 is considered to be the area representing a light emission part. For this reason, in this area, the video signal is maintained as it is without suppressing its luminance as the backlight luminance is stretched through the luminance stretching processing. As a result, the screen luminance is enhanced to allow highly quality image display with an improved feeling of brightness.

In this case, when the black detection portion 19 detects a large amount of black and therefore stretching of the backlight luminance is not performed, the video signal is controlled according to a γ curve on which the screen luminance for the maximum tone value is 550 (cd/m²). This means that as the max luminance determined according to the amount of black detected by the black detection portion glows larger, the curve drawn through J1 to J4 shifts toward the high-tone side. A γ curve drawn through J1 to J2 does not need to be the same as a γ curve following the reference luminance. The γ curve drawn through J1 to J2 that creates a difference between the γ curve and a γ curve including an enhanced area in the light emission part is applicable, and such a γ curve can be set by properly adjusting the gain G4.

### EXPLANATIONS OF LETTERS OR NUMERALS

1 Light emission detecting portion
2 Luminance stretching
3 Backlight luminance stretch portion
4 Backlight control portion
5 Backlight portion
6 Video signal luminance stretch portion
7 Mapping portion
8 Display control portion
9 Display portion
10 Black detection portion
11 Signal processing portion
12 Light emission detecting portion
13 Mapping portion
14 Area-active-control/luminance-stretching portion
15 Backlight control portion
16 Backlight portion
17 Display control portion
18 Display portion
19 Black detection portion

1.-15. (canceled)

16. A video display device comprising:
a display portion for displaying an input video signal;
a light source for illuminating the display portion; and
a control portion for controlling the display portion and the light source, wherein the control portion determines an amount of stretching of luminance of the light source based on a given feature quantity related to brightness of the input video signal and stretches luminance of the light source based on the amount of stretching of luminance,
the video display device further comprises a black detection portion that detects an amount of black display from the input video signal based on a given condition, and
when an amount of black display detected by the black detection portion is within a given range, the control portion limits an amount of stretching of luminance determined based on the given feature quantity according to the amount of black display, and detects a light emission part of the input video signal based on the given feature quantity or a different feature quantity, and then stretches a video signal for the light emission part to display the stretched video signal on the display portion.

17. The video display device as defined in claim 16, wherein
the given feature quantity is a luminance value of an input video signal, wherein
the control portion detecting the light emission part that is regarded as a video emitting light based on the predetermined feature quantity, detects a light emission quantity defined in advance according to a score given by counting pixels with luminance per pixel being weighted for an input video signal in a given range including the detected light emission part, and determines an amount of stretching of luminance of the light source according to the detected light emission quantity.

18. The video display device as defined in claim 17, wherein
the different feature quantity is a maximum RGB tone value for each of pixels of the input video signal, and
the control portion detects a light emission quantity of a light emission part defined in advance according to an average of the maximum RGB tone values of the input video signal, and determines an amount of stretching of luminance of the light source according to the detected light emission quantity.

19. The video display device as defined in claim 17, wherein
the control portion executes video processing for converting and outputting an input tone of an input video signal, and
the video processing includes processing for
detecting the light emission part that is regarded as a video emitting light based on the predetermined feature quantity, setting a given characteristics change point in an area of the detected light emission part,
applying a gain to a video signal with a tone lower than the characteristics change point so that an input tone of the input video signal at the characteristics change point is stretched to a given output tone, and
setting an output tone to the input tone in an area of input tone equal to or higher than the characteristics change point, such that the output tone resulting from application of the gain at the characteristics change point is connected to a maximum output tone.

20. The video display device as defined in claim 17, wherein
the control portion executes video processing for converting and outputting an input tone of an input video signal and outputting the input video signal, and
the video processing includes processing for
defining in advance a relation between a gain applied to a video signal and the light emission quantity and determining the gain according to the light emission quantity detected from the input video signal;
applying the determined gain to the input video signal to stretch the input video signal;
determining an input tone at a point at which an output tone resulting from application of the gain is stretched to a given output tone, to be a characteristics change point;
outputting the video signal with the output tone resulting from application of the gain in an area of tone lower than the characteristics change point; and
setting an output tone to an input tone in an area of input tone equal to or higher than the characteristics change point such that the output tone resulting from application of the gain is connected to a maximum output tone.

21. The video display device as defined in claim 19, wherein
the video processing includes processing for giving a prescribed gain to the input video signal to stretch the input video signal and then giving a compression gain to the video signal to reduce its output tone in a given area of a non-light emission part other than the light emission part.

22. The video display device as defined in claim 21, wherein
the compression gain is determined to be a value that reduces an increment of display luminance resulting from stretching of luminance of the light source and stretching of a video signal by application of the gain thereto.

23. A video display device comprising:
a display portion for displaying an input video signal;
a light source for illuminating the display portion; and a control portion for controlling the display portion and the light source, wherein
the control portion detecting a light emission part that is regarded as a video emitting light based on a predetermined feature quantity of an input video signal,
determines an amount of stretching of luminance of the light source based on a different feature quantity of the input video signal and based on the determined amount of stretching of luminance, stretches the luminance of the light source to increase the luminance, and reduces luminance of a video signal for a non-light emission part other than the light emission part, thereby enhances display luminance of the light emission part,
the video display device further comprises a black detection portion that detects an amount of black display from the input video signal based on a given condition, and
when an amount of black display detected by the black detection portion is within a given range, the control portion limits an amount of stretching of luminance determined based on the given feature quantity according to the amount of black display.

24. The video display device as defined in claim 23, wherein
the different feature quantity is a tone value of an input video signal, and
the control portion divides an image created by the input video signal into multiple areas, changes a lighting rate in an area for the light source based on a tone value of a video signal for each of the divided areas, and determines the amount of stretching of luminance based on an average lighting rate over all the areas.

25. The video display device as defined in claim 24, wherein
the control portion defines in advance a relation between the average lighting rate and maximum luminance that can be taken on a screen of the display portion, and determines the amount of stretching of luminance based on the maximum luminance determined according to the average lighting rate.

26. The video display device as defined in claim 23, wherein
in a given area in which the feature quantity is small, the control portion reduces an increment of display luminance of the display portion resulting from stretching of luminance of the light source by reducing luminance of the video signal.

27. A television receiving device including the video display device as defined in claim 16.
